(19) United States
(12) Patent Application Publication
(10) Pub. No.: US 2021/0380178 A1
(43) Pub. Date: Dec. 9, 2021

(54) Systems and Methods for Safe Reconfiguration of a Vehicle Interior

(71) Applicant: UATC, LLC, San Francisco, CA (US)

(72) Inventor: Daniel Adam Kanitz, Pittsburgh, PA (US)

(21) Appl. No.: 16/923,626

(22) Filed: Jul. 8, 2020

Related U.S. Application Data
(60) Provisional application No. 63/034,428, filed on Jun. 4, 2020.

(51) Int. Cl. B62D 47/00; B60N 2/02; B60R 7/04; B60R 16/037

(52) U.S. Cl. CPC B62D 47/003; B60N 2/0292; B60R 7/04; G05D 1/0088; B60R 16/0373; B60N 2002/0268; B60N 2/0244

(57) ABSTRACT

Systems and methods for safe reconfiguration of a vehicle interior are provided. A method includes obtaining vehicle reconfiguration data indicative of a reconfigured interior arrangement for a vehicle interior of an autonomous vehicle. The reconfigured interior arrangement can include a number of interior vehicle components at one or more different positions within the vehicle interior than a current position of the interior vehicle components as prescribed by a current interior arrangement of the vehicle interior. The method includes obtaining sensor data indicative of one or more objects associated with the autonomous vehicle and determining a potential impact of repositioning the number of interior vehicle components from the current interior arrangement to the reconfigured interior arrangement. The method includes initiating a vehicle reconfiguration response based on the vehicle reconfiguration data and the potential impact of the reconfigured interior arrangement on the one or more objects associated with the autonomous vehicle.

### RELATED APPLICATION

The present application is based on and claims benefit of U.S. Provisional Patent Application No. 63/034,428 having a filing date of Jun. 4, 2020, which is incorporated by reference herein.

### FIELD

The present disclosure relates generally to autonomous vehicles and, more particularly, safe reconfiguration of autonomous vehicles.

### BACKGROUND

An autonomous vehicle can be capable of sensing its environment and navigating with little to no human input. In particular, an autonomous vehicle can observe its surrounding environment using a variety of sensors and can attempt to comprehend the environment by performing various processing techniques on data collected by the sensors. Given such knowledge, an autonomous vehicle can navigate through the environment.

### SUMMARY

Aspects and advantages of embodiments of the present disclosure will be set forth in part in the following description, or may be learned from the description, or may be learned through practice of the embodiments.

An example aspect of the present disclosure is directed to a computer-implemented method. The method can include obtaining, by a computing system including one or more computing devices, vehicle reconfiguration data indicative of a reconfigured interior arrangement for a vehicle interior of an autonomous vehicle. The reconfigured interior arrangement can be different from a current interior arrangement of the vehicle interior. The method can include obtaining, by the computing system, sensor data indicative of one or more objects associated with the autonomous vehicle. The method can include determining, by the computing system, a potential impact of the reconfigured interior arrangement on the one or more objects associated with the autonomous vehicle based at least in part on the vehicle reconfiguration data and the sensor data. And, the method can include initiating, by the computing system, a vehicle reconfiguration response based at least in part on the vehicle reconfiguration data and the potential impact of the reconfigured interior arrangement on the one or more objects associated with the autonomous vehicle.

An example aspect of the present disclosure is directed to an autonomous vehicle. The autonomous vehicle can include a vehicle interior arranged in accordance with a current interior arrangement and a vehicle computing system. The vehicle computing system can include one or more vehicle sensors, one or more processors, and one or more non-transitory computer-readable media that collectively store instructions that, when executed by the one or more processors, cause the system to perform operations. The operations can include obtaining vehicle reconfiguration data indicative of a reconfigured interior arrangement for the vehicle interior that is different from the current interior arrangement of the vehicle interior. The operations can include obtaining sensor data indicative of one or more objects associated with the autonomous vehicle. The operations can include determining first presence data based at least in part on the sensor data. The first presence data indicates at least one of a first current location or first predicted location of the one or more objects. The operations can include determining a potential impact of the reconfigured interior arrangement on the one or more objects associated with the autonomous vehicle based at least in part on the vehicle reconfiguration data and the presence data. And, the operations can include initiating a vehicle reconfiguration response based at least in part on the vehicle reconfiguration data and the potential impact of the reconfigured interior arrangement on the one or more objects associated with the autonomous vehicle.

Yet another example aspect of the present disclosure is directed to a computing system. The computing system includes one or more processors and one or more non-transitory computer-readable media that collectively store instructions that, when executed by the one or more processors, cause the system to perform operations. The operations include obtaining vehicle reconfiguration data indicative of a reconfigured interior arrangement for the vehicle interior that is different from the current interior arrangement of the vehicle interior. The operations include obtaining presence data associated with one or more objects associated with the autonomous vehicle. The presence data indicates at least one of a current or a predicted location of the one or more objects. The one or more objects include at least one of a user or an item associated with a vehicle service provided via the autonomous vehicle. The operations include determining a potential impact of the reconfigured interior arrangement on a first object of the one or more objects associated with the autonomous vehicle based at least in part on the vehicle reconfiguration data and the presence data. And, the operations include initiating a vehicle reconfiguration response based at least in part on the vehicle reconfiguration data and the potential impact of the reconfigured interior arrangement on the first object. The vehicle reconfiguration response can include at least one of vehicle reconfiguration or a reconfiguration prompt.

Other example aspects of the present disclosure are directed to other systems, methods, vehicles, apparatuses, tangible non-transitory computer-readable media, and the like for safe reconfiguration of a vehicle interior. The autonomous vehicle technology described herein can help improve the safety of passengers of an autonomous vehicle, improve the safety of the surroundings of the autonomous vehicle, improve the experience of the rider and/or operator of the autonomous vehicle, as well as provide other improvements as described herein. Moreover, the autonomous vehicle technology of the present disclosure can help improve the ability of an autonomous vehicle to effectively provide vehicle services to others and support the various members of the community in which the autonomous vehicle is operating, including persons with reduced mobility and/or persons that are underserved by other transportation options. Additionally, the autonomous vehicle of the present disclosure may reduce traffic congestion in communities as well as provide alternate forms of transportation that may provide environmental benefits.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example system for controlling the computational functions of an autonomous vehicle according to example embodiments of the present disclosure;

FIG. 2A depicts an autonomous vehicle according to example embodiments of the present disclosure;

FIG. 2B depicts an autonomous vehicle interior according to example embodiments of the present disclosure;

FIG. 3A depicts configurations for a passenger seat of an autonomous vehicle according to example embodiments of the present disclosure;

FIG. 3B depicts another configuration for a passenger seat of an autonomous vehicle according to example embodiments of the present disclosure;

FIG. 4 depicts a top down view of a first example seating configuration of an autonomous vehicle's interior according to example embodiments of the present disclosure;

FIG. 5 depicts a top down view of a second example seating configuration of an autonomous vehicle's interior according to example embodiments of the present disclosure;

FIG. 6 depicts a top down view of a third example seating configuration of an autonomous vehicle's interior according to example embodiments of the present disclosure;

FIG. 7 depicts a dataflow diagram for determining a reconfiguration response according to example embodiments of the present disclosure;

FIG. 8 depicts an example transportation services infrastructure system according to example embodiments of the present disclosure;

FIG. 9 depicts a top down view of an example reconfiguration between two example seating configurations according to example embodiments of the present disclosure;

FIG. 10 depicts a flowchart of a method for initiating a reconfiguration response according to example embodiments of the present disclosure;

FIG. 11 depicts example units associated with a computing system for performing operations and functions according to example embodiments of the present disclosure; and

FIG. 12 depicts a block diagram of example computing hardware according to example embodiments of the present disclosure.

### DETAILED DESCRIPTION

Aspects of the present disclosure are directed to improved systems and methods for dynamic seat reconfiguration of an autonomous vehicle. In particular, aspects of the present disclosure are directed to ensuring the safe reconfiguration of the reconfigurable vehicle interior of an autonomous vehicle. An autonomous vehicle, for example, can include a reconfigurable vehicle interior with configurable components (e.g., passenger seats, tables, etc.) that can be rearranged to accommodate a number of different seating configurations (e.g., pooling configurations, social configurations, meeting configurations, family configurations, etc.). Each component can include attachment mechanisms (e.g., locks, levers, wheels, etc.) that can couple the component to one or more interior locking mechanisms (e.g., tracks, rails, etc.) within the base of the vehicle interior. The position of the component(s) within a vehicle interior can be changed (e.g., by moving the component via the attachment mechanisms, interior locking mechanisms, etc.) to reconfigure the vehicle interior from a first seating configuration to a second seating configuration. This can be done automatically, for example, to enable an autonomous vehicle to facilitate a variety of different transportation services and different preferences of passengers for a variety of transportation services. The present disclosure is directed to systems and methods for safely initiating reconfigurations of an autonomous vehicle's interior.

As described herein, a computing system can obtain sensor data and reconfiguration data. The sensor data can identify object(s) proximate to and/or within an autonomous vehicle. The reconfiguration data can identify a reconfigured interior arrangement different from the current interior arrangement of the autonomous vehicle. The computing system can identify impacted areas (e.g., impacted zones) within the interior of the autonomous vehicle that are (or would be) affected by reconfiguring the interior of the autonomous vehicle from the current interior arrangement to the reconfigured interior arrangement. The computing system can determine whether any object(s) are currently or predicted to be located in or proximate to the impacted areas and initiate a vehicle reconfiguration response accordingly. For example, the computing system can initiate a reconfiguration prompt (e.g., a reconfiguration warning, a request to vacate the impacted area, etc.) in the event that an object is located within an impacted area and/or initiate a vehicle reconfiguration in the event that no object is located within an impacted area. In this manner, the systems and methods of the present disclosure can ensure safety during the reconfiguration of a vehicle's interior by accounting for any obstruction within an impacted area. Before each reconfiguration, passengers of a vehicle can be notified of the reconfiguration and the reconfiguration can be postponed, delayed, cancelled, etc. if a passenger is or predicted to be within an area of the vehicle interior that will be impacted by the reconfiguration. In this way, the computing system can increase passenger comfort and safety while riding in a reconfigurable vehicle by dynamically determining whether a reconfiguration is appropriate based on knowledge of the vehicle's interior and/or surroundings.

The following describes the technology of this disclosure within the context of autonomous vehicles for example purposes only. As described herein, the technology described herein is not limited to autonomous vehicles and can be implemented within other robotic and computing systems, such as those utilized by a ridesharing and/or delivery services.

An autonomous vehicle can be a ground-based vehicle, aerial vehicle, and/or another type of vehicle. The autonomous vehicle can perform vehicle services for one or more service entities. A service entity can be associated with the provision of one or more vehicle services. For example, a service entity can be an individual, a group of individuals, a company (e.g., a business entity, organization, etc.), a group of entities (e.g., affiliated companies), and/or another type of entity that offers and/or coordinates the provision of vehicle service(s) to one or more users. As an example, a service entity can offer vehicle service(s) to users via a software application (e.g., on a user computing device), via a website, and/or via other types of interfaces that allow a user to request a vehicle service. The vehicle services can include user transportation services (e.g., by which the vehicle transports user(s) from one location to another), delivery services (e.g., by which a vehicle delivers item(s) to a requested destination location), courier services (e.g., by which a vehicle retrieves item(s) from a requested origin location and delivers the item to a requested destination location), and/or other types of services.

An operations computing system of the service entity can help to coordinate the performance of vehicle services by autonomous vehicles. For instance, the operations computing system can include a service platform. The service platform can include a plurality of back-end services and front-end interfaces, which are accessible via one or more APIs. For example, an autonomous vehicle and/or another computing system that is remote from the autonomous vehicle can communicate/access the service platform (and its backend services) by calling the one or more APIs. Such components can facilitate secure, bidirectional communications between autonomous vehicles and/or the service entity's operations system (e.g., including a data center, etc.). The service platform can allow an autonomous vehicle to obtain data from and/or communicate data to the operations computing system. By way of example, a user can provide (e.g., via a user device) a request for a vehicle service to the operations computing system associated with the service entity.

The autonomous vehicle can include a computing system (e.g., a vehicle computing system) with a variety of components for operating with minimal and/or no interaction from a human operator. For example, the computing system can be located onboard the autonomous vehicle and include one or more sensors (e.g., cameras, Light Detection and Ranging (LiDAR), Radio Detection and Ranging (RADAR), etc.), an autonomy computing system (e.g., for determining autonomous navigation), one or more vehicle control systems (e.g., for controlling braking, steering, powertrain), etc. The autonomy computing system can include a number of sub-systems that cooperate to perceive the surrounding environment of the autonomous vehicle and determine a motion plan for controlling the motion of the autonomous vehicle.

For example, the autonomy computing system can include a perception system configured to perceive one or more objects within the surrounding environment of the autonomous vehicle, a prediction system configured to predict a motion of the object(s) within the surrounding environment of the autonomous vehicle, and a motion planning system configured to plan the motion of the autonomous vehicle with respect to the object(s) within the surrounding environment of the autonomous vehicle. For example, the motion planning system can determine a motion plan in accordance with a determined route and/or one or more objects along the route. In some implementations, one or more of the number of sub-systems can be combined into one system. For example, an autonomy computing system can include a perception/prediction system configured to perceive and predict a motion of one or more objects within the surrounding environment of the autonomous vehicle.

The vehicle computing system can include and/or be associated with a plurality of external sensors (e.g., LiDAR sensors, outward facing cameras, etc.) and/or interior sensors (e.g., internal facing cameras/heat sensors, internal facing microphones, tactile sensors (e.g., touch sensors within seats of a vehicle interior, on the handle of a vehicle door, etc.), etc.). The plurality of sensors can be placed throughout the vehicle to obtain sensor data indicative of the presence of objects and/or humans currently and/or predicted to be within and/or proximate to the vehicle's interior. The sensor data, for example, can be obtained by the interior sensors such as one or more cameras configured to obtain image data, one or more microphones configured to obtain auditory data, one or more tactile sensors configured to obtain tactile data (e.g., to detect a touch to a seat to determine whether an object and/or passenger is placed on or sitting in a passenger seat, etc.). In addition, or alternatively, the sensor data can be obtained by the external sensors such as one or more external sensors configured to detect a passenger or object in the process of entering and/or exiting the vehicle. For instance, the external sensors can include infrared sensors that wrap around the vehicle (e.g., a side of the vehicle that includes an entry and/or exit to the vehicle, etc.), camera(s), LiDAR sensors, microphones, tactile sensors (e.g., to detect a touch to a door (e.g., a handle of the door) of the vehicle, etc.), etc. In addition, other sensors can be utilized to generate and/or obtain sensor data such as, for example, ultrasonic sensors, RADAR sensor (e.g., placed along the side of the vehicle, etc.) and/or any other sensor capable of generating and/or obtaining data indicative of an object and/or passenger's proximity to a vehicle.

In some implementations, the vehicle computing system can be configured to process the sensor data to detect objects and/or passengers (e.g., an elbow, hand, foot, etc.) relative to an area (e.g., zone) within the vehicle interior and/or an entry or exit of the vehicle. By way of example, the vehicle computing system can utilize one or more sensor processing models (image processing and/or or any other sensor processing model(s)) configured to detect the objects and/or passengers. For instance, the sensor processing models can include one or more machine-learned models learned to analyze the sensor data and/or one or more portions of the sensor data and output an indication of the location, heading, and/or other information for any passenger(s) and/or object(s) proximate to or within the vehicle.

In some implementations, the sensor processing models can include multiple machine-learned models configured to output the same and/or similar information based on one or more different portions of the sensor data (e.g., detection information based on image data, detection information based on tactile data, etc.). The redundancy from multiple sensor suites and/or processing models can confirm and/or increase the vehicle computing system's confidence in the detection of the one or more objects and/or passengers. In some implementations, the sensor processing models can include the same machine-learned models used by one or more perception and/or predictions systems of the autonomy computing system. In addition, or alternatively, the sensor processing models can include different machine-learned models that use algorithms/models similar to the models used by the one or more perception and/or prediction systems.

In some implementations, the vehicle can include one or more sensory cues (e.g., visual cues such as paint, contouring, lighting, etc.) on one or more interior (e.g., passenger seats, etc.) and/or exterior (e.g., passenger doors, etc.) components of the vehicle. The sensory cures can be used to enhance the detection accuracy of the one or more sensor processing models. For example, the one or more sensory cues can give a frame of reference for one or more portions of the vehicle. By way of example, as discussed in greater detail herein, the vehicle can include a plurality of zones identifying different portions of the vehicle. In some implementations, the vehicle can include one or more sensory cues that define each of the plurality of portions. By way of example, the sensory cues can include paint, electrical signals, reflective surfaces, edging/contouring, etc. that identify a particular portion (e.g., a door, a front portion of the vehicle interior, etc.) of the vehicle. In this manner, the one or more sensor processing models can compare the location of one or more objects and/or passengers relative to the one or more sensory cues to determine whether an object and/or passenger is located proximate to one or more zones of the vehicle.

A computing system (e.g., vehicle computing system, remote operations computing system, etc.) can obtain sensor data indicative of one or more object(s) and/or passenger(s) and determine whether a reconfiguration of the vehicle's interior is appropriated based one or more impacted zones of an autonomous vehicle. By way of example, an autonomous vehicle can include a vehicle interior defining a longitudinal direction, a lateral direction, and a vertical direction. The vehicle interior can include one or more vehicle seats to support one or more passengers of the vehicle and/or one or more vehicle doors to enable the one or more passengers to enter and/or exit the vehicle interior. For instance, the vehicle interior can include a floorboard with one or more mechanical components (e.g., sliding tracks, spring loaded levers, locking pins, and/or other locking mechanisms, etc.) placed therein configured to couple one or more mechanical components (e.g., sliding skids, wheels, spring loaded levers, locking pins, and/or any the attachment mechanisms, etc.) of the vehicle seats to the floor of the vehicle interior. The mechanical components can be placed throughout the floor of the vehicle interior to enable a plurality of different seat configurations within the autonomous vehicle.

The autonomous vehicle can be capable of adjusting its vehicle interior to provide for one or more dynamic seat reconfigurations to more efficiently provide a number of specialized services. More particularly, the autonomous vehicle can include one or more seats that can individually or collectively be reconfigured (e.g., reconfiguration of a seat orientation and/or a seat position). As an example, a seat of the autonomous vehicle can change location inside the autonomous vehicle (e.g., by sliding longitudinally along a track inside the cabin of the autonomous vehicle, etc.). As another example, a seat of the autonomous vehicle can change an orientation inside the autonomous vehicle (e.g., fully retracting a headrest in the seat, changing an angle of the seat back of the seat, folding the seat back onto the seat base of the seat to form a table, etc.). In such fashion, the seating arrangement of seats in the autonomous vehicle can be dynamically reconfigured to more efficiently provide a number of different services.

The interior of the autonomous vehicle can include a vehicle layout indicative of an arrangement of a plurality of interior components (e.g., seats, tables, etc.). An arrangement (e.g., seating arrangement) can include at least a first set of passenger seats and/or a second set of passenger seats that are spaced apart along a longitudinal axis of the autonomous vehicle. The first and/or second set of passenger seats can be configurable in a first configuration in which a seating orientation of the passenger seats can be directed towards a first end (e.g., forward end) and/or a second configuration in which a seating orientation of the passenger seats can be directed towards a second end (e.g., a rear end) of the autonomous vehicle. In addition, the seat(s) can be configurable in a third configuration in which the seats are folded for storage and/or to act as a tabletop. The seats can be arranged in a plurality of different configurations to create different vehicle layout.

As an example, a first seating arrangement can include a first set of one or more rows of seats (e.g., three rows of two seats) spaced apart along the longitudinal axis of the vehicle interior. The seating orientation of each of the passenger seats can be directed towards the same end (e.g., first end) of the autonomous vehicle. In some implementations, the autonomous vehicle can include a plurality of portions such that each of the passenger seats can be positioned in a different portion of the vehicle interior. As another example, a second seating arrangement can include a second set of one or more rows of seats. The second set of the one or more rows of seats can include two rows of passenger seats (e.g., one row in a first configuration, a second row in a second configuration, etc.) and one row of seats folded for storage (e.g., in a third configuration). Each of the passenger seats can be positioned in a different portion of the vehicle interior. In addition, one or more of the seats folded for storage can be positioned in the same portion as a respective passenger seat.

As a third example, a third seating arrangement can include a third set of one or more rows of seats. The third set of the one or more rows of seats can include two rows of passenger seats (e.g., unfolded seats in a first and/or second configuration) and one row of tabletop seats (e.g., seats folded according to the third configuration). Each of the passenger seats and the tabletop seats can be positioned in a different portion of the vehicle interior. For example, a first row of passenger seats can include one or more passenger seats with a seating orientation directed towards the second end (e.g., rear end) of the vehicle, a second row of passenger seats can include one or more passenger seats with a seating orientation directed towards the first end (e.g., forward end) of the vehicle, and the row of tabletop seats can be placed between the first row of deployed seats and the second row of deployed seats such that passengers sitting in either row can use the row of tabletop seats as a table.

A computing system (e.g., vehicle computing system, remote operations computing system, etc.) can initiate the reconfiguration of the vehicle interior from any current interior arrangement (e.g., as indicated by the vehicle layout) to any reconfigured interior arrangement (e.g., as indicated by reconfiguration data) based on information indicative of the vehicle interior and the reconfiguration of the vehicle interior. For example, the computing system can obtain vehicle data indicative of the interior of the vehicle. The vehicle data can include the sensor data (e.g., sensor data described above) and/or configuration data. The configuration data can be indicative of a current interior arrangement (e.g., a vehicle layout) of the vehicle interior. For example, as discussed above, the vehicle interior of an autonomous vehicle can include a plurality of interior portions and one or more interior components (e.g., one or more passenger seats, tables, etc.). Each respective interior arrangement of a plurality of interior arrangements can be indicative of a placement of the one or more interior components on one or more respective portions of the plurality of interior portions. As an example, the plurality of interior components can be passenger seats, storage areas, tables, wheelchair supports, etc. The configuration data can identify a current seating arrangement for the autonomous vehicle. For example, the configuration data can identify each of the plurality of interior portions of the autonomous vehicle and one or more interior components located on, coupled to, etc. one or more of the interior portions of the autonomous vehicle at a current time.

A service provider can receive a request for a transportation service. The request can include a service type (e.g., pooling type, premium type, etc.), a number of passengers, one or more accommodations, a pick-up location, a destination location, and/or any other information related to a transportation service. For example, a computing system (e.g., a transportation services system, a vehicle computing system, etc.) can obtain a transportation service request from a user of a transportation service provider. The transportation service request can include service request data indicative of at least an origin location and a number of passengers.

The computing system can determine whether a reconfiguration is required to complete service request based on the service request data and/or the configuration data associated with the autonomous vehicle. For example, the computing system can determine a reconfigured interior arrangement for servicing the transportation request based, at least in part, on the number of passengers and/or one or more other factors associated with the transportation request. The reconfigured interior arrangement can be determined from a plurality of predefined interior arrangements such as, for example, the first interior arrangement, the second interior arrangement, and/or the third interior arrangement discussed herein. Each predefined interior arrangement can indicate a placement and/or orientation of one or more interior components of a vehicle interior on one or more interior portions of the vehicle interior.

In some implementations, the computing system can include an operations computing system (e.g., with a vehicle service management service/system) associated with one or more autonomous vehicles. In such a case, the computing system can search for a vehicle capable of completing the service request (e.g., based on a vehicle location, availability, etc.). In some implementations, the computing system can preferably select a vehicle capable of completing the transportation service with a current interior arrangement that is the same as the reconfigured interior arrangement. For example, the computing system can obtain vehicle data including vehicle location data indicative of a geographic location of the one or more vehicles associated with the service entity (or a third party vehicle provider) and configuration data indicative of a respective current interior arrangement associated with each respective vehicle of the one or more vehicles. The computing system can select a vehicle from the one or more autonomous vehicles based, at least in part, on the vehicle data, the reconfigured interior arrangement for servicing the transportation service request, and the origin location. For example, the computing system can balance the cost of reconfiguring the interior arrangement of a vehicle with an estimated distance of one or more vehicle(s) from an origin location of the transportation request.

In some implementations, the computing system (e.g., operations computing system) can select an autonomous vehicle that requires a reconfiguration of its interior to satisfy the transportation request. In response, the computing system can determine service assignment data for the selected vehicle based, at least in part, on the reconfigured interior arrangement and the data indicative of the current interior arrangement associated with the vehicle. The service assignment data can include service request data (e.g., an origin location, number of passengers, etc.) and vehicle reconfiguration data. The vehicle reconfiguration data can include an interior arrangement of a plurality of vehicle interior arrangements that is different than the current vehicle interior arrangement of the autonomous vehicle. The computing system can provide the service assignment data (e.g., service request data, vehicle reconfiguration data, etc.) to the autonomous vehicle.

In addition, or alternatively, the operations computing system can provide for fleet-wide reconfigurations by providing the vehicle reconfiguration data to a plurality of autonomous vehicles. For instance, the operations computing system can determine that a plurality of vehicles can be reconfigured based on one or more external factors (e.g., demand curve matching, load balancing, high capacity incentivization in peak demand times/locations, emergency evacuation situations (e.g., due to weather, etc.), etc.). For instance, the computing system can determine, based on a number of collected service requests, one or more environmental factors (e.g., emergency weather conditions, etc.), that an interior configuration can be beneficial for a number of autonomous vehicles in one or more similar geographic regions and/or at one or more different times. For example, the computing system can determine that an entire fleet of autonomous vehicles can be reconfigured in the same manner based at least in part on service request data included in the service request, environmental data, etc. As another example, the computing system can determine an interior configuration that can be beneficial for a number of autonomous vehicles located in a certain geographic area (e.g., a high-density urban area, a low-density rural area, etc.) based on one or more current events (e.g., high density events such as a sporting event, music festival, etc.), one or more traffic patterns (e.g., high density traffic after work hours, etc.). In such a case, the computing system can provide the reconfiguration data to each of the number of autonomous vehicles.

As an example, the computing system can determine from a number of service requests, environmental data, traffic data, current event data, etc. a preferred seat configuration that maximizes a number of passengers (e.g., to lower an associated ride cost, increase the number of transported passengers over time (e.g., to timely evacuate persons from an area, etc.), etc.) for one or more autonomous vehicles in a geographic region at one or more times. In response, the computing system can provide reconfiguration data to each of the one or more autonomous vehicles in the geographic area to reconfigure the autonomous vehicles to a seating configuration that maximizes a number of passengers of the autonomous vehicle. In such fashion, the computing system can determine an optimal default configuration for an entire fleet of autonomous vehicles and/or a subset of a fleet of autonomous vehicles. In this manner, the operations computing system can cause the fleet and/or the subset of the fleet of vehicles to reconfigure concurrently (and/or substantially concurrently) based on market demand, collated service request data, one or more emergency situations, and/or any other external factor affecting the transfer needs of passengers.

In this way, vehicle reconfiguration data indicative of a reconfigured interior arrangement for a vehicle interior of the autonomous vehicle can be obtained. The reconfiguration data can be indicative of a vehicle reconfiguration in which one or more components within the interior of a vehicle are rearranged to define another interior arrangement. For instance, the reconfiguration data can include an adjustment to at least one of a position or orientation of the plurality of seats within the vehicle interior and/or a position or orientation of the one or more storage areas within the vehicle interior. The reconfigured interior arrangement can be different from a current interior arrangement of the vehicle interior.

The computing system can determine one or more zones of the vehicle interior based, at least in part, on the vehicle reconfiguration data. The one or more zones can include a portion of the vehicle. Each zone, for example, can include a portion of the vehicle classified based on the impact of an interior reconfiguration on the portion of the vehicle. By way of example, the one or more zones can include at least one impacted zone. The at least one impacted zone can include a portion of the vehicle that is classified as “impacted” by a reconfiguration from a current interior arrangement to a reconfigured interior arrangement, as further described herein.

The zone(s) can be predetermined and/or dynamically determined. For example, the zone(s) of the vehicle interior can be predetermined for the autonomous vehicle based on each possible reconfiguration of the vehicle's interior. For example, the computing system can include and/or have access to a vehicle zone database. The vehicle zone database can include a plurality of classifications (e.g., impacted, clear, in-between, etc.) for each portion of the autonomous vehicle based on a reconfiguration from each pair (e.g., one interior arrangement to another interior arrangement) of predefined interior arrangement. In some implementations, the computing system can determine the one or more zones by matching the current interior arrangement and the reconfigured interior arrangement of the reconfiguration data to a pair of interior arrangements of the vehicle zone database.

In addition, or alternatively, a computing system can dynamically determine the one or more zones. For instance, the computing system can identify one or more affected components of the vehicle interior that can move during the reconfiguration and determine the one or more zones based on the portions of the vehicle interior on which the one or more affected components are currently and/or predicted to be placed. By way of example, as discussed in further detail below, the computing system can determine an impact level for each portion of the autonomous vehicle based on the one or more affected components and determine the one or more zones based on the impact level.

The one or more zones can include one or more impacted zones (e.g., stay out zones, hazard zones, etc.), one or more clear zones, and/or one or more in-between zones. The one or more impacted zones, for example, can be indicative of one or more interior portions of the vehicle interior associated with a high impact level (e.g., high likelihood that the portion will be affected by a reconfiguration). For instance, the high impact level can be above an impact threshold level (e.g., over 50% chance that the portion will be affected by the reconfiguration). The one or more clear zones can be indicative of one or more interior portions associated with a low impact level (e.g., low likelihood that the portion will be affected by the reconfiguration). For instance, the low impact level can be below a clear threshold (e.g., under a 50% chance that the portion will be affected by the reconfiguration). The one or more in-between zones can include an area surrounding at least one impacted zone. For example, the at least one impacted zone can be associated with a proximity threshold that identifies an area surrounding the at least one impacted zone. The proximity threshold of the at least one impacted zone can be indicative of one or more interior portions associated with a proximity impact level between the clear threshold level and the impact threshold level (e.g., a 50% chance that the portion will be affected by the reconfiguration). For example, the impacted zone can include a portion of the vehicle interior directly impacted by a reconfiguration and the proximity threshold can include a safe distance from the impacted portion of the vehicle interior.

In some implementations, the computing system can determine the zone(s) by assigning an impact level to a plurality of portions of the vehicle interior. For example, the computing system can assign an impact level to one or more portions of the vehicle interior. The computing system can determine the impact level for one or more of the plurality of interior portions based, at least in part, on the reconfigured interior arrangement and the current interior arrangement. The impact level for a respective interior portion, for example, can be indicative of an estimated impact on the respective interior portion during the vehicle reconfiguration. For example, the impact level can be determined based on the one or more components of the vehicle interior that will be moved during the reconfiguration. For example, an interior portion where a seat that is to be moved during reconfiguration is currently placed, where the seat will be moved after reconfiguration, and/or the area in between can be associated with a higher impact level (e.g., above an impact threshold). In addition, or alternatively, an interior portion where a seat is located that is not expected to move during a reconfiguration can be associated with a lower impact level (e.g., under a clear threshold). In some implementations, the computing system can determine a total impact for the autonomous vehicle during of a reconfiguration operation. The total impact can be based on the impact level to one or more interior portions of the vehicle interior.

As described above, a computing system can obtain sensor data indicative of the one or more objects and/or passengers associated with the autonomous vehicle. The computing system can determine presence data based on the sensor data and/or the one or more zones of the autonomous vehicle. The presence data, for example, can be indicative of a position of an object with respect to the at least one impacted zone. For example, the presence data can identify a current and/or predicted location of an object relative to the impacted zone(s) of the autonomous vehicle. By way of example, the presence data can be indicative of a predicted position of the object and/or passenger with respect to at least one impacted zone. In this manner, the computing system can detect passenger(s) (and/or object(s)) in or in the process of entering a vehicle interior before reconfiguring the vehicle interior. As used herein, for example, one or more objects can include one or more users associated with the autonomous vehicle for a requested vehicle service and/or one or more items associated with the autonomous vehicle for a requested vehicle service.

The computing system can determine a potential impact of the reconfigured interior arrangement on the one or more objects associated with the autonomous vehicle based at least in part on the vehicle reconfiguration data and the sensor data (e.g., presence data). To do so, the computing system can obtain and/or determine data indicative of the one or more zones and determine that at least one of the zones is an impacted zone based on the vehicle interior arrangement (e.g., in the manner described herein). The computing system can determine the current and/or predicted location of the object(s) with respect to the one or more zones associated with the autonomous vehicle and determine whether at least one object is currently located and/or is predicted to be located within an impacted zone based on the zone data and the presence data. For example, the computing system can determine that the at least one object is located within at least one impacted zone based at least in part on the current position of the object (e.g., as indicated by the presence data). In addition, or alternatively, the computing system can determine that the at least one object is predicted to be located within the at least one impacted zone based at least in part on the predicted position (e.g., as indicated by the presence data) of the object.

The computing system (e.g., vehicle computing system) can initiate a vehicle reconfiguration response based at least in part on the vehicle reconfiguration data and the potential impact of the reconfigured interior arrangement on one or more objects associated with the autonomous vehicle. For example, the vehicle reconfiguration response can include initiating a vehicle reconfiguration, initiating one or more reconfiguration prompts, and/or rejecting a vehicle reconfiguration. By way of example, the computing system can initiate the vehicle reconfiguration in the event no objects are present within and/or proximate to an impacted zone of the autonomous vehicle. In addition, or alternatively, the computing system can initiate one or more reconfiguration prompts and/or reject a vehicle reconfiguration in the event that at least one object is present within and/or proximate to an impacted zone of the autonomous vehicle.

As an example, the computing system can determine that at least one object of the one or more objects is or is predicted to be located outside of the proximity threshold associated with the at least one impacted zone based on the presence data. The computing system can initiate a vehicle reconfiguration of the vehicle interior in response to determining that the at least one object of the one or more objects is or is predicted to be located outside of the proximity threshold. For example, the computing system can activate one or more mechanisms, actuators, etc. to move one or more seats, partitions, etc. within the interior of the vehicle to obtain the reconfigured vehicle arrangement specified by the reconfiguration data. By way of example, the vehicle reconfiguration of the vehicle interior can include a transition from the placement of the one or more interior components at one or more current portions of the plurality of interior portions in accordance with the current interior arrangement to one or more assigned portions of the plurality of interior portions in accordance with the reconfigured interior arrangement.

As another example, the computing system can determine that at least one object of the one or more objects is within the proximity threshold associated with the at least one impacted zone based, at least in part, on the presence data. The computing system can initiate a reconfiguration prompt and/or reject the vehicle reconfiguration in response to determining that the at least one object of the one or more objects is within the proximity threshold. By way of example, the computing system can reject the vehicle reconfiguration in response to determining that the at least one object of the one or more object is within the proximity threshold. In such a case, the vehicle computing system can communicate rejection data to the operations computing system indicating that the vehicle may not perform the vehicle reconfiguration. The operations computing system can receive the rejection data and, in response, select another vehicle from the one or more autonomous vehicles to complete the transportation service.

In addition, or alternatively, the operations computing system can determine one or more actions for the vehicle to enable the reconfiguration. For example, the operations computing system can alter a route of the vehicle. The altered route can include one or more intermediate stops. For example, an intermediate stop can include a maintenance location where the vehicle interior can be inspected (e.g., to identify and remove any obstruction preventing a vehicle reconfiguration). In some implementations, the intermediate stop(s) can include intermediate drop-off locations where the vehicle can drop off one or more passengers within the vehicle interior (e.g., to clear any passengers from an impacted area). For example, the altered route can prioritize one or more intermediate drop-off locations over the pick-up location for a transportation services request to clear one or more portions of the vehicle interior. In this manner, the vehicle can be instructed to travel along the altered route and initiate the vehicle reconfiguration before arriving at the pick-up location (e.g., after the one or more impacted zone(s) of the vehicle interior are clear of any objects and/or passengers).

In some implementations, the computing system can issue a reconfiguration prompt. The reconfiguration prompt, for example, can include a sensory prompt (e.g., visual prompt via a user interface, a tactile prompt via one or more tactile devices within the vehicle, auditory prompt via one or more speakers within the vehicle, etc.) provided to one or more passengers associated with the vehicle. The prompt can be indicative of the reconfiguration. For example, the prompt can identify the one or more impacted zones of the vehicle and/or one or more hazard zones (e.g., areas directly and/or indirectly impacted by the reconfiguration). In addition, the prompt can identify one or more clear areas. For example, a prompt can include a request for the passenger to move to a clear area, move away from an impacted area, exit the vehicle, move an object (e.g., luggage, etc.) from an impacted area to a clear area, avoid/delay boarding the vehicle, etc.

In some implementations, the computing system can monitor the interior of the vehicle during an interior reconfiguration. For instance, the computing system can be configured to continuously collect sensor data indicative of the interior of the vehicle during the interior reconfiguration. The sensor data can include the data described above. In addition, or alternatively, the sensor data can include component data indicative a state of one or more moveable components of the vehicle interior. For instance, the sensors can include a sensor on each individual actuator, motor, and/or any other mechanism configured to move a component within the vehicle interior. The component data can be indicative of one or more torque spikes and/or other mechanical health information. The computing system can be configured to halt a reconfiguration in the event that the one or more sensors detect an abnormality associated with the operation of any of the one or more moveable components. In some implementations, the computing system can reject the vehicle reconfiguration, in the manner described above, in response to halting the reconfiguration.

In addition, the computing system can obtain, via the one or more vehicle sensors, second presence data indicative of a second proximity of the object(s) to the at least one impacted zone during the reconfiguration of the vehicle interior. The second presence data can be different than the first presence data. For example, the second presence data can include the first presence data updated during the reconfiguration. The computing system can be configured to halt a reconfiguration, issue a reconfiguration prompt, and/or reject a reconfiguration, in the manner described above, in the event that the second presence data is indicative of an object within a proximity to one or more impacted zones.

In some implementations, the computing system can monitor the reconfiguration to confirm that the vehicle reconfiguration has completed. For example, the computing system can determine that the one or more interior components of the vehicle interior are arranged in accordance with the reconfigured interior arrangement. In some implementations, the computing system can generate a confirmation prompt indicating that the vehicle reconfiguration is completed. The computing system can communicate, via one or more output devices, the confirmation prompt to the one or more passengers of the autonomous vehicle (e.g., in the manner described above with reference to the reconfiguration prompts).

The systems and methods described herein provide a number of technical effects and benefits. For instance, by determining the potential impact of the reconfiguration of a vehicle interior on one or more objects associated with a vehicle, the computing system described herein can safely and effectively facilitate the reconfiguration of a vehicle interior. Moreover, reconfiguration prompts can be issued to passengers that enable a vehicle to communicate with passengers before, during, and/or after an interior reconfiguration. This can improve ride-sharing operations by adjusting the reconfiguration operations of a vehicle's interior based on the presence of persons or objects with a vehicle. In this manner, the systems and methods described herein can improve the safety of ride sharing operations by ensuring that the reconfiguration of a vehicle's interior does not interfere with any person or object within the vehicle before initiating the reconfiguration. This, in turn, can proactively prevent the halting of a reconfiguration due to obstructions. Moreover, by identifying the presence of obstructions before a reconfiguration operation, the systems and methods described herein can reduce the need for manual overrides and/or stop commands. This can reduce the processing and analysis needed to complete a reconfiguration while also reducing the potential stress, wear, and tear on a vehicle's hardware components that can be caused by abrupt stops (e.g., emergency halting, stopping, etc.) to the reconfiguration of a vehicle's interior.

Example aspects of the present disclosure can provide a number of improvements to computing technology such as, for example, ride sharing transportation computing technology. For instance, the systems and methods of the present disclosure can provide an improved approach for safe reconfiguration of a vehicle's interior. For example, a computing system can obtain vehicle reconfiguration data indicative of a reconfigured interior arrangement for a vehicle interior of an autonomous vehicle. The reconfigured interior arrangement can be different from a current interior arrangement of the vehicle interior. The computing system can obtain sensor data indicative of one or more objects associated with the autonomous vehicle. The computing system can determine a potential impact of the reconfigured interior arrangement on the one or more objects associated with the autonomous vehicle based at least in part on the vehicle reconfiguration data and the sensor data. And, the computing system can initiate a vehicle reconfiguration response based at least in part on the vehicle reconfiguration data and the potential impact of the reconfigured interior arrangement on one or more objects associated with the autonomous vehicle.

In this manner, the computing system can employ improved techniques (e.g., reconfiguration techniques) to determine whether the reconfiguration of a vehicle's interior is safe for one or more passengers and/or objects associated with a vehicle. Moreover, the computing system can accumulate and utilize newly available information such as, for example, sensor data descriptive of objects and/or passengers associated with a vehicle, zone data indicative of impacted or clear areas within the vehicle, and presence data indicative of the position of the objects and/or passengers with respect to the impacted or clear areas within the vehicle. In this way, the computing system provides a practical application that enables the safe and efficient reconfiguration of vehicle interiors.

Various means can be configured to perform the methods and processes described herein. For example, a computing system can include data obtaining unit(s), zone unit(s), presence unit(s), impact unit(s), initiation unit(s), and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry, for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means (e.g., data obtaining unit(s), etc.) can be configured to obtain vehicle reconfiguration data indicative of a reconfigured interior arrangement for a vehicle interior of an autonomous vehicle. The reconfigured interior arrangement can be different from a current interior arrangement of the vehicle interior. In addition, the means (e.g., data obtaining unit(s), etc.) can be configured to obtain sensor data indicative of one or more objects associated with the autonomous vehicle.

The means (e.g., zone unit(s), etc.) can be configured to determine one or more zones of the vehicle interior based, at least in part, on the vehicle reconfiguration data. The one or more zones can include at least one impacted zone. The means (e.g., presence unit(s), etc.) can be configured to determine first presence data based at least in part on the sensor data. The first presence data can indicate at least one of a first current location or first predicted location of the one or more objects. For instance, the first presence data can indicate at least one or a first current location or first predicted location of the one or more object with respect to the at least one impacted zone.

The means (e.g., impact unit(s), etc.) can be configured to determine a potential impact of the reconfigured interior arrangement on the one or more objects associated with the autonomous vehicle based at least in part on the vehicle reconfiguration data and the sensor data. In addition, the means (e.g., impact unit(s), etc.) can be configured to determine a potential impact of the reconfigured interior arrangement on the one or more objects associated with the autonomous vehicle based at least in part on the vehicle reconfiguration data and the presence data. The means (e.g., initiation unit(s), etc.) can be configured to initiate a vehicle reconfiguration response based at least in part on the vehicle reconfiguration data and the potential impact of the reconfigured interior arrangement on the one or more objects associated with the autonomous vehicle.

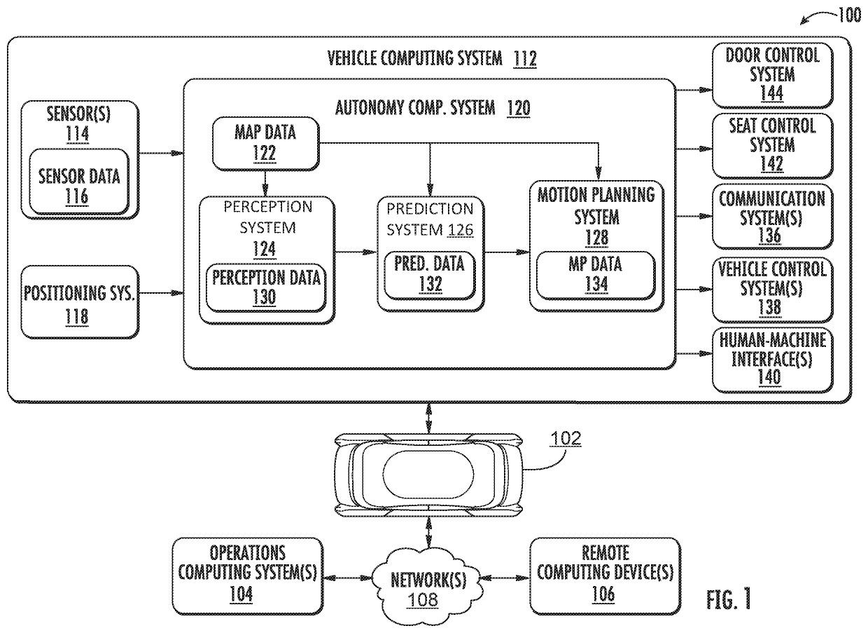

With reference now to FIGS. 1-11, example embodiments of the present disclosure will be discussed in further detail. FIG. 1 depicts a block diagram of an example system 100 for controlling the navigation of a vehicle according to example embodiments of the present disclosure. As illustrated, FIG. 1 shows an example system 100 that can include an autonomous vehicle 102, an operations computing system 104, one or more remote computing devices 106, a communication network 108, a vehicle computing system 112, one or more sensors 114, sensor data 116, a positioning system 118, an autonomy computing system 120, map data 122, a perception system 124, a prediction system 126, a motion planning system 128, state data 130, prediction data 132, motion plan data 134, a communication system 136, a vehicle control system 138, and a human-machine interface 140.

The operations computing system 104 can be associated with a service provider (e.g., service entity) that can provide one or more vehicle services to a plurality of users via a fleet of vehicles (e.g., service entity vehicles, third-party vehicles, etc.) that includes, for example, the autonomous vehicle 102. The vehicle services can include transportation services (e.g., rideshare services), courier services, delivery services, and/or other types of services.

The operations computing system 104 can include multiple components for performing various operations and functions. For example, the operations computing system 104 can include and/or otherwise be associated with the one or more computing devices that are remote from the autonomous vehicle 102. The one or more computing devices of the operations computing system 104 can include one or more processors and one or more memory devices. The one or more memory devices of the operations computing system 104 can store instructions that when executed by the one or more processors cause the one or more processors to perform operations and functions associated with the operation of one or more vehicles (e.g., a fleet of vehicles), with the provision of vehicle services, and/or other operations as discussed herein.

For example, the operations computing system 104 can be configured to monitor and communicate with the autonomous vehicle 102 and/or its users to coordinate a vehicle service provided by the autonomous vehicle 102. To do so, the operations computing system 104 can manage a database that stores data including vehicle status data associated with the status of vehicles including autonomous vehicle 102. The vehicle status data can include a state of a vehicle, a location of a vehicle (e.g., a latitude and longitude of a vehicle), the availability of a vehicle (e.g., whether a vehicle is available to pick-up or drop-off passengers and/or cargo, etc.), and/or the state of objects internal and/or external to a vehicle (e.g., the physical dimensions and/or appearance of objects internal/external to the vehicle).

The operations computing system 104 can communicate with the one or more remote computing devices 106 and/or the autonomous vehicle 102 via one or more communications networks including the communications network 108. The communications network 108 can exchange (send or receive) signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communications network 108 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the autonomous vehicle 102.

Each of the one or more remote computing devices 106 can include one or more processors and one or more memory devices. The one or more memory devices can be used to store instructions that when executed by the one or more processors of the one or more remote computing devices 106 cause the one or more processors to perform operations and/or functions including operations and/or functions associated with the autonomous vehicle 102 including exchanging (e.g., sending and/or receiving) data or signals with the autonomous vehicle 102, monitoring the state of the autonomous vehicle 102, and/or controlling the autonomous vehicle 102. The one or more remote computing devices 106 can communicate (e.g., exchange data and/or signals) with one or more devices including the operations computing system 104 and the autonomous vehicle 102 via the communications network 108.

The one or more remote computing devices 106 can include one or more computing devices (e.g., a desktop computing device, a laptop computing device, a smart phone, and/or a tablet computing device) that can receive input or instructions from a user or exchange signals or data with an item or other computing device or computing system (e.g., the operations computing system 104). Further, the one or more remote computing devices 106 can be used to determine and/or modify one or more states of the autonomous vehicle 102 including a location (e.g., latitude and longitude), a velocity, acceleration, a trajectory, and/or a path of the autonomous vehicle 102 based in part on signals or data exchanged with the autonomous vehicle 102. In some implementations, the operations computing system 104 can include the one or more remote computing devices 106.

The autonomous vehicle 102 can be a ground-based vehicle (e.g., an automobile, bike, scooter, other light electric vehicle, etc.), an aircraft, and/or another type of vehicle. The autonomous vehicle 102 can perform various actions including driving, navigating, and/or operating, with minimal and/or no interaction from a human driver. The autonomous vehicle 102 can be configured to operate in one or more modes including, for example, a fully autonomous operational mode, a semi-autonomous operational mode, a park mode, and/or a sleep mode. A fully autonomous (e.g., self-driving) operational mode can be one in which the autonomous vehicle 102 can provide driving and navigational operation with minimal and/or no interaction from a human driver present in the vehicle. A semi-autonomous operational mode can be one in which the autonomous vehicle 102 can operate with some interaction from a human driver present in the vehicle. Park and/or sleep modes can be used between operational modes while the autonomous vehicle 102 performs various actions including waiting to provide a subsequent vehicle service, and/or recharging between operational modes.

An indication, record, and/or other data indicative of the state of the vehicle, the state of one or more passengers of the vehicle, and/or the state of an environment including one or more objects (e.g., the physical dimensions and/or appearance of the one or more objects) can be stored locally in one or more memory devices of the autonomous vehicle 102. Additionally, the autonomous vehicle 102 can provide data indicative of the state of the vehicle, the state of one or more passengers of the vehicle, and/or the state of an environment to the operations computing system 104, which can store an indication, record, and/or other data indicative of the state of the one or more objects within a predefined distance of the autonomous vehicle 102 in one or more memory devices associated with the operations computing system 104 (e.g., remote from the vehicle). Furthermore, the autonomous vehicle 102 can provide data indicative of the state of the one or more objects (e.g., physical dimensions and/or appearance of the one or more objects) within a predefined distance of the autonomous vehicle 102 to the operations computing system 104, which can store an indication, record, and/or other data indicative of the state of the one or more objects within a predefined distance of the autonomous vehicle 102 in one or more memory devices associated with the operations computing system 104 (e.g., remote from the vehicle).

The autonomous vehicle 102 can include and/or be associated with the vehicle computing system 112. The vehicle computing system 112 can include one or more computing devices located onboard the autonomous vehicle 102. For example, the one or more computing devices of the vehicle computing system 112 can be located on and/or within the autonomous vehicle 102. The one or more computing devices of the vehicle computing system 112 can include various components for performing various operations and functions. For instance, the one or more computing devices of the vehicle computing system 112 can include one or more processors and one or more tangible, non-transitory, computer readable media (e.g., memory devices). The one or more tangible, non-transitory, computer readable media can store instructions that when executed by the one or more processors cause the autonomous vehicle 102 (e.g., its computing system, one or more processors, and other devices in the autonomous vehicle 102) to perform operations and functions, including those described herein.

As depicted in FIG. 1, the vehicle computing system 112 can include one or more sensors 114, the positioning system 118, the autonomy computing system 120, the communication system 136, the vehicle control system(s) 138, and the human-machine interface 140. One or more of these systems can be configured to communicate with one another via a communication channel. The communication channel can include one or more data buses (e.g., controller area network (CAN)), on-board diagnostics connector (e.g., OBD-II), and/or a combination of wired and/or wireless communication links. The onboard systems can exchange (e.g., send and/or receive) data, messages, and/or signals amongst one another via the communication channel.

The sensor(s) 114 can include a plurality of external sensors (e.g., LiDAR sensors, outward facing cameras, etc.) and/or internal sensors (e.g., tactile sensors (e.g., touch sensors within seats of a vehicle interior, on the handle of a vehicle door, etc.), internal facing microphones, internal facing cameras, etc.). As discussed herein, the internal sensor(s) and/or external sensor(s) can be utilized by the vehicle computing system 112 to gather internal sensor data associated with a vehicle 102 such as, for example, occupancy data identifying the state (e.g., the position and/or orientation) of one or more passengers riding within the vehicle 102.

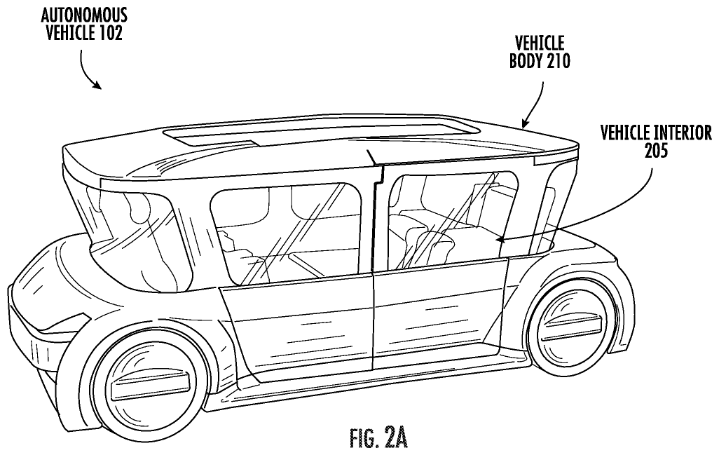

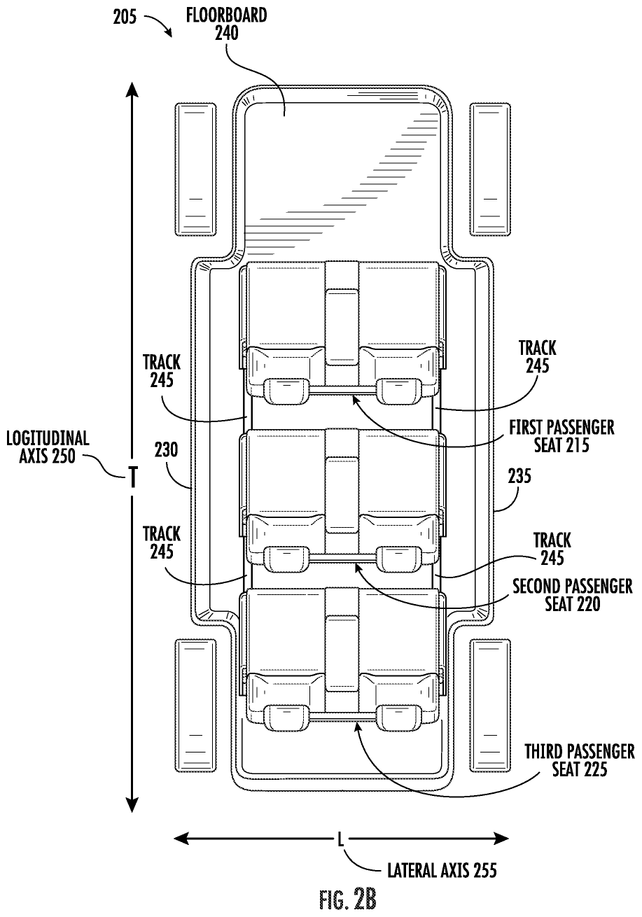

More particularly, the vehicle computing system 112 can include and/or be associated with a plurality of external sensors (e.g., LiDAR sensors, outward facing cameras, etc.) and/or interior sensors (e.g., internal facing cameras/heat sensors, internal facing microphones, tactile sensors (e.g., touch sensors within seats of a vehicle interior, on the handle of a vehicle door, etc.), etc.). With reference to FIG. 2A, the sensor(s) 114 can be located on various parts of the autonomous vehicle 102 including the vehicle interior 205, a front side, rear side, left side, right side, top, or bottom of the vehicle body 210, etc. For instance, the sensor(s) 114 can be placed throughout the vehicle 102 to obtain sensor data indicative of the presence of objects and/or humans currently and/or predicted to be within and/or proximate to the vehicle's interior 205. The sensor data, for example, can be obtained by the interior sensors such as one or more cameras configured to obtain image data, one or more microphones configured to obtain auditory data, one or more tactile sensors configured to obtain tactile data (e.g., to detect a touch to a seat to determine whether an object and/or passenger is placed on or sitting in a passenger seat, etc.), heat sensor(s), weight sensor(s), etc. In addition, or alternatively, the sensor data can be obtained by the external sensors such as one or more external sensors configured to detect a passenger or object in the process of entering and/or exiting the vehicle's interior 205. For instance, the external sensors can include infrared sensors that wrap around the vehicle's body 210 (e.g., a side of the vehicle that includes an entry and/or exit to the vehicle, etc.), camera(s), LiDAR sensors, microphones, tactile sensors (e.g., to detect a touch to a door (e.g., a handle of the door) of the vehicle, etc.), etc. In addition, other sensors can be utilized to generate and/or obtain sensor data such as, for example, ultrasonic sensors, RADAR sensor (e.g., placed along the side of the vehicle, etc.) and/or any other sensor capable of generating and/or obtaining data indicative of an object and/or passenger's proximity to the vehicle 102.

Turning back to FIG. 1, the vehicle computing system 112 can be configured to process the sensor data 116 to detect objects and/or passengers (e.g., an elbow, hand, foot, etc.) relative to an area (e.g., zone) within the vehicle interior 205 and/or an entry or exit of the vehicle's interior 205. By way of example, the vehicle computing system 112 can utilize one or more sensor processing models (image processing and/or or any other sensor processing model(s)) configured to detect the objects and/or passengers. For instance, the sensor processing models can include one or more machine-learned models learned to analyze the sensor data 116 and/or one or more portions of the sensor data 116 and output an indication of the location, heading, and/or other information for any passenger(s) and/or object(s) proximate to or within the vehicle 102.

In some implementations, the sensor processing models can include multiple machine-learned models configured to output the same and/or similar information based on one or more different portions of the sensor data 116 (e.g., detection information based on image data, detection information based on tactile data, etc.). The redundancy from multiple sensor suites and/or processing models can confirm and/or increase the vehicle computing system's confidence in the detection of the one or more objects and/or passengers. In some implementations, the sensor processing models can include the same machine-learned models used by one or more perception 124 and/or predictions systems 126 of the autonomy computing system 120 (as described in further detail below). In addition, or alternatively, the sensor processing models can include different machine-learned models that use algorithms/models similar to the models used by the one or more perception 124 and/or prediction systems 126.

In some implementations, the vehicle 102 can include one or more sensory cues (e.g., visual cues such as paint, contouring, lighting, etc.) on one or more interior (e.g., passenger seats, etc.) and/or exterior (e.g., passenger doors, etc.) components of the vehicle 102. The sensory cues can be used to enhance the detection accuracy of the one or more sensor processing models. For example, the one or more sensory cues can give a frame of reference for one or more portions of the vehicle 102. By way of example, as discussed in greater detail herein, the vehicle 102 can include a plurality of zones identifying different portions of the vehicle 102. In some implementations, the vehicle 102 can include one or more sensory cues that define each of the plurality of portions. By way of example, the sensory cues can include paint, electrical signals, reflective surfaces, edging/contouring, etc. that identify a particular portion (e.g., a door, a front portion of the vehicle interior, etc.) of the vehicle 102. In this manner, the one or more sensor processing models can compare the location of one or more objects and/or passengers relative to the one or more sensory cues to determine whether an object and/or passenger is located proximate to one or more zones of the vehicle.

The sensor(s) 114 can be configured to generate and/or store data including the sensor data 116. The sensor data 116 can include the internal sensor data, external sensor discussed above, and well an autonomy sensor data associated with one or more objects that are proximate to the autonomous vehicle 102 (e.g., within range or a field of view of one or more of the one or more sensors 114 (e.g., external sensor(s)). For instance, the sensor(s) 114 can include a Light Detection and Ranging (LIDAR) system, a Radio Detection and Ranging (RADAR) system, one or more cameras (e.g., visible spectrum cameras and/or infrared cameras), motion sensors, and/or other types of imaging capture devices and/or sensors. The autonomy sensor data can include image data, radar data, LIDAR data, and/or other data acquired by the sensor(s) 114. The one or more objects can include, for example, pedestrians, vehicles, bicycles, and/or other objects. The autonomy sensor data can be indicative of locations associated with the one or more objects within the surrounding environment of the autonomous vehicle 102 at one or more times. For example, the autonomy sensor data can be indicative of one or more LIDAR point clouds associated with the one or more objects within the surrounding environment. The sensor(s) 114 can provide autonomy sensor data to the autonomy computing system 120.

In addition to the sensor data 116, the autonomy computing system 120 can retrieve or otherwise obtain data including the map data 122. The map data 122 can provide detailed information about the surrounding environment of the autonomous vehicle 102. For example, the map data 122 can provide information regarding: the identity and location of different roadways, road segments, buildings, or other items or objects (e.g., lampposts, crosswalks and/or curb), the location and directions of traffic lanes (e.g., the location and direction of a parking lane, a turning lane, a bicycle lane, or other lanes within a particular roadway or other travel way and/or one or more boundary markings associated therewith), traffic control data (e.g., the location and instructions of signage, traffic lights, or other traffic control devices), and/or any other map data that provides information that assists the vehicle computing system 112 in processing, analyzing, and perceiving its surrounding environment and its relationship thereto.

The vehicle computing system 112 can include a positioning system 118. The positioning system 118 can determine a current position of the autonomous vehicle 102. The positioning system 118 can be any device or circuitry for analyzing the position of the autonomous vehicle 102. For example, the positioning system 118 can determine position by using one or more of inertial sensors, a satellite positioning system, based on IP/MAC address, by using triangulation and/or proximity to network access points or other network components (e.g., cellular towers and/or Wi-Fi access points) and/or other suitable techniques. The position of the autonomous vehicle 102 can be used by various systems of the vehicle computing system 112 and/or provided to one or more remote computing devices (e.g., the operations computing system 104 and/or the remote computing device 106). For example, the map data 122 can provide the autonomous vehicle 102 relative positions of the surrounding environment of the autonomous vehicle 102. The autonomous vehicle 102 can identify its position within the surrounding environment (e.g., across six axes) based at least in part on the data described herein. For example, the autonomous vehicle 102 can process the autonomy sensor data (e.g., LIDAR data, camera data) to match it to a map of the surrounding environment to get an understanding of the vehicle's position within that environment (e.g., transpose the autonomous vehicle's 102 position within its surrounding environment).

The autonomy computing system 120 can include a perception system 124, a prediction system 126, a motion planning system 128, and/or other systems that cooperate to perceive the surrounding environment of the autonomous vehicle 102 and determine a motion plan for controlling the motion of the autonomous vehicle 102 accordingly. In some examples, many of the functions performed by the perception system 124, prediction system 126, and motion planning system 128 can be performed, in whole or in part, by a single system and/or multiple systems that share one or more computing resources. For instance, one or more of the perception system 124, prediction system 126, and motion planning system 128 can be combined into one system configured to perform the functions of each of the systems. In addition, or alternatively, the one or more of the perception system 124, prediction system 126, and motion planning system 128 can be configured to share and/or have access to one or more common computing resources (e.g., a shared memory, communication interfaces, processors, etc.).

As an example, the autonomy computing system 120 can receive the sensor data 116 from the one or more sensors 114, attempt to determine the state of the surrounding environment and/or the vehicle's interior by performing various processing techniques on the sensor data 116 (and/or other data). The autonomy computing system 120 can generate an appropriate motion plan through the surrounding environment based on state of the surrounding environment and the vehicle's interior. In some examples, the autonomy computing system 120 can use the sensor data 116 as input to a one or more machine-learned models that can detect objects within the sensor data 116, forecast future motion of those objects, and select an appropriate motion plan for the autonomous vehicle 102. The machine-learned model(s) can be included within one system and/or share one or more computing resources.

As another example, the perception system 124 can identify one or more objects that are proximate to and/or within the autonomous vehicle 102 based on sensor data 116 received from the sensor(s) 114. In particular, in some implementations, the perception system 124 can determine, for each object, state data 130 that describes the current state of such object. As examples, the state data 130 for each object can describe an estimate of the object's: current location (e.g., relative to one or more interior vehicle components, the surrounding environment of the vehicle, etc.); current speed; current heading (which may also be referred to together as velocity); current acceleration; current orientation (e.g., with respect to the direction of travel of the vehicle, etc.); size/footprint (e.g., as represented by a bounding shape such as a bounding polygon or polyhedron); class of characterization (e.g., vehicle class versus pedestrian class versus bicycle class versus other class); yaw rate; and/or other state information. In some implementations, the perception system 124 can determine state data 130 for each object over a number of iterations. In particular, the perception system 124 can update the state data 130 for each object at each iteration. Thus, the perception system 124 can detect and track objects (e.g., vehicles, bicycles, pedestrians, etc.) that are proximate and/or within the autonomous vehicle 102 over time, and thereby produce a presentation of the world around and within the vehicle 102 along with its state (e.g., a presentation of the objects of interest within a scene/vehicle interior at the current time along with the states of the objects).

The prediction system 126 can receive the state data 130 from the perception system 124 and predict one or more future locations and/or moving paths for each object based on such state data 130. For example, the prediction system 126 can generate prediction data 132 associated with each of the respective one or more objects proximate and/or within the vehicle 102. The prediction data 132 can be indicative of one or more predicted future locations of each respective object. The prediction data 132 can be indicative of a predicted path (e.g., predicted trajectory) of at least one object within the interior and/or the surrounding environment of the autonomous vehicle 102. For example, the predicted path (e.g., trajectory) can indicate a path along which the respective object is predicted to travel over time (and/or the velocity at which the object is predicted to travel along the predicted path). The prediction system 126 can provide the prediction data 132 associated with the one or more objects to the motion planning system 128.

The motion planning system 128 can determine a motion plan and generate motion plan data 134 for the autonomous vehicle 102 based at least in part on the prediction data 132 (and/or other data). The motion plan data 134 can include vehicle actions with respect to the objects proximate to the autonomous vehicle 102 as well as the predicted movements. For instance, the motion planning system 128 can implement an optimization algorithm that considers cost data associated with a vehicle action as well as other objective functions (e.g., cost functions based on speed limits, traffic lights, and/or other aspects of the environment), if any, to determine optimized variables that make up the motion plan data 134. By way of example, the motion planning system 128 can determine that the autonomous vehicle 102 can perform a certain action (e.g., pass an object) without increasing the potential risk to the autonomous vehicle 102 and/or violating any traffic laws (e.g., speed limits, lane boundaries, signage). The motion plan data 134 can include a planned trajectory, velocity, acceleration, and/or other actions of the autonomous vehicle 102.

As one example, in some implementations, the motion planning system 128 can determine a cost function for each of one or more candidate motion plans for the autonomous vehicle 102 based at least in part on the current locations and/or predicted future locations and/or moving paths of the objects. For example, the cost function can describe a cost (e.g., over time) of adhering to a particular candidate motion plan. For example, the cost described by a cost function can increase when the autonomous vehicle 102 approaches impact with another object and/or deviates from a preferred pathway (e.g., a predetermined travel route).

Thus, given information about the current locations and/or predicted future locations and/or moving paths of objects, the motion planning system 128 can determine a cost of adhering to a particular candidate pathway. The motion planning system 128 can select or determine a motion plan for the autonomous vehicle 102 based at least in part on the cost function(s). For example, the motion plan that minimizes the cost function can be selected or otherwise determined. The motion planning system 128 then can provide the selected motion plan to a vehicle control system 138 that controls one or more vehicle controls (e.g., actuators or other devices that control gas flow, steering, braking, etc.) to execute the selected motion plan.

The motion planning system 128 can provide the motion plan data 134 with data indicative of the vehicle actions, a planned trajectory, and/or other operating parameters to the vehicle control systems 138 to implement the motion plan data 134 for the autonomous vehicle 102.

The vehicle computing system 112 can include a communications system 136 configured to allow the vehicle computing system 112 (and it's one or more computing devices) to communicate with other computing devices. The vehicle computing system 112 can use the communications system 136 to communicate with the operations computing system 104 and/or one or more other remote computing devices (e.g., the one or more remote computing devices 106) over one or more networks (e.g., via one or more wireless signal connections, etc.). In some implementations, the communications system 136 can allow communication among one or more of the systems on-board the autonomous vehicle 102. The communications system 136 can also be configured to enable the autonomous vehicle to communicate with and/or provide and/or receive data and/or signals from a remote computing device 106 associated with a user and/or an item (e.g., an item to be picked-up for a courier service). The communications system 136 can utilize various communication technologies including, for example, radio frequency signaling and/or Bluetooth low energy protocol. The communications system 136 can include any suitable components for interfacing with one or more networks, including, for example, one or more: transmitters, receivers, ports, controllers, antennas, and/or other suitable components that can help facilitate communication. In some implementations, the communications system 136 can include a plurality of components (e.g., antennas, transmitters, and/or receivers) that allow it to implement and utilize multiple-input, multiple-output (MIMO) technology and communication techniques.

The vehicle computing system 112 can include one or more human-machine interfaces 140. For example, the vehicle computing system 112 can include one or more display devices located on the vehicle computing system 112. A display device (e.g., screen of a tablet, laptop, and/or smartphone) can be viewable by a user of the autonomous vehicle 102 that is located in the front of the autonomous vehicle 102 (e.g., driver's seat, front passenger seat). Additionally, or alternatively, a display device can be viewable by a user of the autonomous vehicle 102 that is located in the rear of the autonomous vehicle 102 (e.g., a passenger seat in the back of the vehicle).

In some implementations, the vehicle computing system 112 can include a seat control system 142 and/or a door control system 144. The seat control system 142 can be configured to control the operation of one or more configurable seats positioned within the interior of the autonomous vehicle 102. For instance, the seat control system 142 can include one or more actuators (e.g., electric motors) configured to control movement of the one or more configurable seats. As will be discussed herein, the seat control system 142 can configure the interior of the autonomous vehicle 102 to accommodate a plurality of different seating configurations.

The door control system 144 can be configured to control the operation of one or more door assemblies to permit access to the interior of the vehicle 102. For instance, the door control system 144 can include one or more actuators (e.g., electric motors) configured to control movement of the door assembly(s). More specifically, the one or more actuators can move the one or more door assemblies between an open position and a closed position to permit selective access to the interior of the autonomous vehicle 102. In addition, or alternatively, the door control system 144 can be configured to selectively lock and/or unlock the door assembly(s). In such a case, the door assembly(s) can permit the movement (e.g., from a closed position to an open position and/or vice versa) of the door assembly(s) when unlocked and prevent movement of the door assembly(s) when unlocked.

Turning to FIG. 2B, FIG. 2B depicts an example autonomous vehicle interior according to example embodiments of the present disclosure. For example, a vehicle interior 205 can define a longitudinal direction 250 (e.g., along a longitudinal axis), a lateral direction 255 (e.g., along a lateral axis), and a vertical direction (e.g., perpendicular to the lateral and longitudinal axes). The vehicle interior 205 can include one or more vehicle seats 215, 220, 225 to support one or more passengers of the vehicle and/or one or more vehicle doors 230, 235 to enable the one or more passengers to enter and/or exit the vehicle interior 205. For instance, the vehicle interior 205 can include a floorboard 240 with one or more mechanical components 245 (e.g., sliding tracks, spring loaded levers, locking pins, and/or other locking mechanisms, etc.) placed therein configured to couple one or more mechanical components (e.g., sliding skids, wheels, spring loaded levers, locking pins, and/or any the attachment mechanisms, etc.) of the vehicle seats 215, 220, 225 to the floor 240 of the vehicle interior 205. The mechanical components can be placed throughout the floor 240 of the vehicle interior 205 to enable a plurality of different seat configurations within the autonomous vehicle.

The autonomous vehicle can be capable of adjusting its vehicle interior 205 to provide for one or more dynamic seat reconfigurations to more efficiently provide a number of specialized services. By way of example, the autonomous vehicle can include one or more seats 215, 220, 225 that can individually or collectively be reconfigured (e.g., reconfiguration of a seat orientation and/or a seat position). As an example, a seat (e.g., one of 215, 220, 225) within the vehicle interior 205 of the autonomous vehicle can change location inside the autonomous vehicle (e.g., the vehicle interior 205) by sliding longitudinally (e.g., along the longitudinal axis 250) along one or more track(s) 245 inside the vehicle interior 205 of the autonomous vehicle.

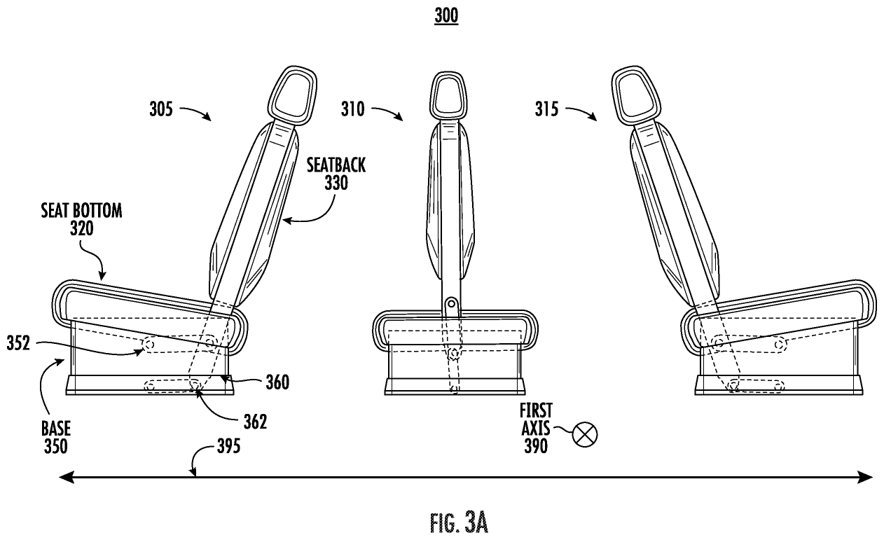

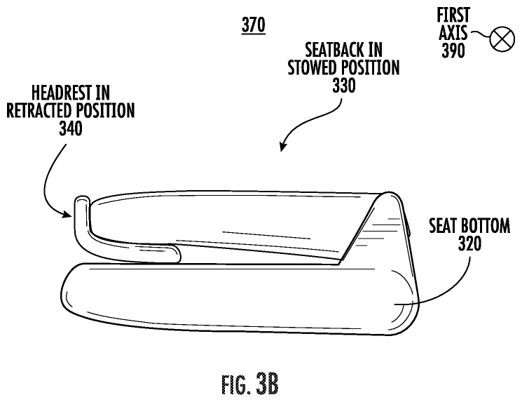

As another example, a seat of the autonomous vehicle can change an orientation inside the autonomous vehicle. For example, FIG. 3A depicts deployed configurations for an example passenger seat 300 of an autonomous vehicle according to example embodiments of the present disclosure. The passenger seat 300 can include a base 350 to which the seatback 330 is pivotably coupled. In this manner, the seatback 330 can rotate about pivot point(s) 352, 362 on the base 350 to switch the passenger seat 300 between the first configuration 305 and the second configuration 315, and intermediate configurations 310 therebetween. For instance, the seatback 330 can rotate about the pivot point(s) 352, 362 in a clockwise direction to switch the passenger seat 300 from the first configuration 305, through the intermediate configuration 310, to the second configuration 315. Conversely, the seatback 330 can rotate about the pivot point(s) 352, 362 in a counterclockwise direction to switch the passenger seat 300 from the second configuration 315, through the intermediate configuration 310, to the first configuration 315.

In some implementations, the seat bottom 320 can be pivotably coupled to the base 350 of the passenger seat 300 via one or more linkage arms 360 (“seat linkage arm”). For instance, the seat bottom 320 can be pivotably coupled to the base 350 via linkage arm(s) 360. The linkage arm(s) 360 can be pivotably coupled to the base 350 at the pivot points 352, 362 thereon. In some implementations, the linkage arm(s) 360 can be disposed within a portion of the base 350 having a shape corresponding to a parallelogram. It should be understood, however, that the linkage arm(s) 360 can be disposed at any suitable location on the base 350.

As shown, movement of the linkage arm(s) 360 about the pivot point(s) 352, 262, respectively, can cause the seat bottom 320 to move (e.g., translate) along the second axis 395 of the passenger seat 300. For instance, movement of the linkage arm(s) 360 can cause the seat bottom 320 to initially rotate about the first axis 390 of the passenger seat 300. More specifically, movement of the linkage arm(s) 360 can initially cause the seat bottom 320 to rotate about the first axis 390 until the tilt angle of seat bottom 320 is 0 degrees (e.g., horizontal). The seat bottom 320 can then translate along the second axis 395 until continued movement (e.g., rotation) of the linkage arm(s) 360 again causes the seat bottom 320 to rotate about the first axis 390. More specifically, the continued movement of the linkage arm(s) 360 can cause the seat bottom 320 to rotate such that the seat bottom 320 is no longer horizontal (that is, the tilt angle is not 0 degrees). It should be understood that the seat bottom 320 can be configured to rotate about the first axis 390 when the seatback 330 is, as discussed above, rotating about the pivot point(s) 352, 362 on the base 350 to switch the passenger seat 300 between the first configuration 305, the intermediate configuration 310, and the second configuration 315.

The seatback 330 of the passenger seat 300 and the seat bottom 320 of the passenger seat 300 can rotate in opposing directions to switch the passenger seat 300 between the first configuration 305, the intermediate configuration 310, and the second configuration 315. For instance, the seat bottom 320 can rotate about the first axis 390 in the counterclockwise direction when the seatback 330 is rotating about the pivot point(s) 352, 362 in the clockwise direction to switch the passenger seat 300 from the first configuration 305 to the second configuration 315. Conversely, the seat bottom 320 can rotate about the first axis 390 in the clockwise direction when the seatback 330 is rotating about the pivot point(s) 352, 362 in the counterclockwise direction to switch the passenger seat 300 from the second configuration 315 to the first configuration 305.

Referring now to FIG. 3B, FIG. 3B depicts another configuration 370 for a passenger seat 300 of an autonomous vehicle according to example embodiments of the present disclosure. As shown, the passenger seat 300 can include a seatback 330. The seatback 330 can be pivotably fixed to the seat bottom 320. In this manner, the seatback 330 of the second passenger seat 300 can rotate about a pivot point on the seat bottom 320 of the passenger seat 300 to move (e.g., rotate) between a deployed position (shown in FIG. 3A) and a stowed position 370. When the seatback 330 of the passenger seat 300 is in the deployed position, the seatback 330 of the passenger seat 300 can be substantially perpendicular (e.g., within 10, 5, 1, etc. degree(s) of 90 degrees) to the seat bottom 320 of the second passenger seat 300. In this manner, the passenger seat 300 can accommodate a passenger when the seatback 330 of the second passenger seat 300 is in the deployed position. Conversely, the seatback 330 of the second passenger seat 300 can be substantially parallel (e.g., less than a 15 degree difference, less than a 10 degree difference, less than a 5 degree difference, less than a 1 degree difference, etc.) to the seat bottom 320 of the second passenger seat 300 when the seatback 330 of the second passenger seat 300 is in the stowed position 370.

In some implementations, the seat bottom 320 of the second passenger seat 300 can be configured to rotate about the first axis 390 when the seatback 330 of the second passenger seat 300 is, as discussed above, rotating about the pivot point on the seat bottom 320 of the second passenger seat 300 to move between the deployed position and the stowed position 370. In some implementations, a tilt angle of the seat bottom 320 of the passenger seat 300 can be less than about 5 degrees when the seatback 330 is in the stowed position 370. In this manner, the seatback 330 of the second passenger seat 300 can fold down onto the seat bottom 320 of the second passenger seat 300 such that the seatback 330 of the second passenger seat 300 can be used as table.

In some implementations, the second passenger seat 300 can include a headrest 340 movable between an extended position and a retracted position. When the seatback 330 of the passenger seat 300 is in the deployed position, the headrest 340 can be in the extended position to provide support for the head of a person seated in the passenger seat 300. Conversely, the headrest 340 can be in the retracted position when the seatback 330 of the passenger seat 300 is in the stowed position 370. In some implementations, the headrest 340 can move from the extended position to the retracted position (e.g., in the seatback) when the seatback 330 of the second passenger seat 300 is moving (e.g., rotating) from the deployed position to the stowed position 370. In such fashion, the seating arrangement of seats in the autonomous vehicle can be dynamically reconfigured to more efficiently provide a number of different services.

To this end, the interior of the autonomous vehicle can include a vehicle layout indicative of an arrangement of a plurality of interior components (e.g., seats, tables, etc.). An arrangement (e.g., seating arrangement) can include at least a first set of passenger seats and/or a second set of passenger seats that are spaced apart along a longitudinal axis of the autonomous vehicle. The first and/or second set of passenger seats can be configurable in a first configuration (e.g., a forward facing deployed position 305) in which a seating orientation of the passenger seats can be directed towards a first end (e.g., forward end) and/or a second configuration (e.g., a rear facing deployed position 315) in which a seating orientation of the passenger seats can be directed towards a second end (e.g., a rear end) of the autonomous vehicle. In addition, the seat(s) can be configurable in a third configuration (e.g., a stowed position 370) in which the seats are folded for storage and/or to act as a tabletop. The seats can be arranged in a plurality of different configurations to create different vehicle layout.

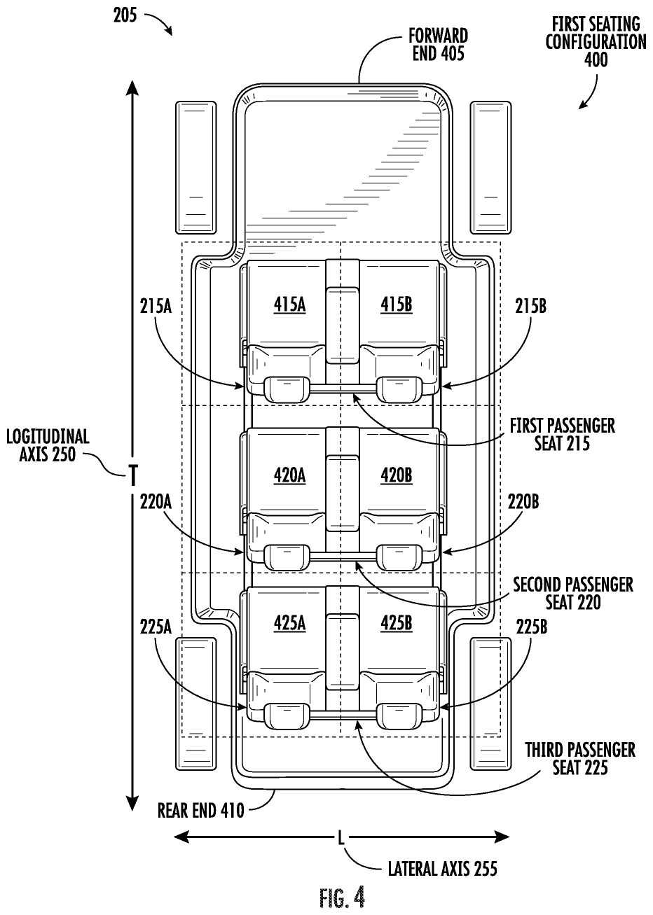

As an example, FIG. 4 depicts a top down view of a first example seating configuration 400 of an autonomous vehicle's interior according to example embodiments of the present disclosure. The first seating arrangement 400 can include a first set of one or more rows of seats 215, 220, 225 (e.g., three rows of two seats) spaced apart along the longitudinal axis 250 of the vehicle interior 205. The seating orientation of each of the passenger seats 215, 220, 225 can be directed towards the same end (e.g., a forward end 405) of the autonomous vehicle. In some implementations, the autonomous vehicle can include a plurality of portions 415A-B, 420A-B, 425A-B such that each of the passenger seats 215, 220, and 215 can be positioned in a different portion of the vehicle interior. For example, the set of passenger seats 215 can include passenger seat 215A located at portion 415A of the vehicle interior 205 and passenger seat 215B located at portion 415B of the vehicle interior 205. In addition, the set of passenger seats 220 can include passenger seat 220A located at portion 420A of the vehicle interior 205 and passenger seat 220B located at portion 420B of the vehicle interior 205. Moreover, the set of passenger seats 225 can include passenger seat 225A located at portion 425A of the vehicle interior 205 and passenger seat 225B located at portion 425B of the vehicle interior 205.

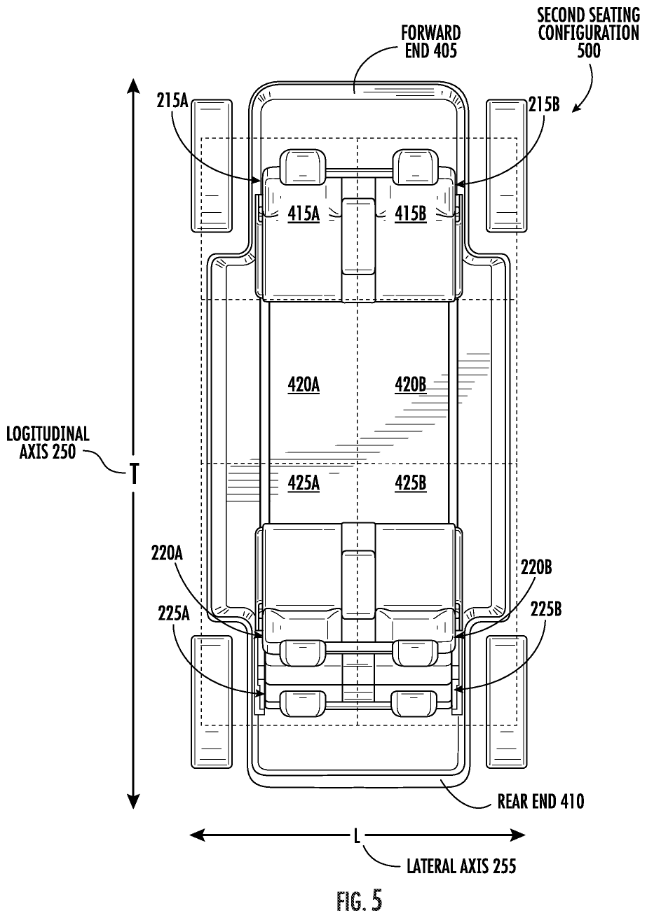

As another example, FIG. 5 depicts a top down view of a second example seating configuration 500 of an autonomous vehicle's interior according to example embodiments of the present disclosure. The second seating arrangement 500 can include a second set of the one or more rows of seats 215, 220, 225. The second set of the one or more rows of seats 215, 220, 225 can include two rows of passenger seats in a deployed position (e.g., one row in a forward facing deployed configuration 305, a second row in a rear facing deployed configuration 315, etc.) and one row of seats 225 folded for storage (e.g., in a stowed position 370). Each of the passenger seats 215A-B, 220A-B, and 225A-B can be positioned in a different portion of the vehicle interior 205. In addition, one or more of the seats 225A-B folded for storage can be positioned in the same portion as a respective passenger seat. By way of example, the set of passenger seats 215 can include passenger seat 215A located at portion 415A of the vehicle interior 205 and passenger seat 215B located at portion 415B of the vehicle interior 205. The set of passenger seats 220 can include passenger seat 220A located at portion 425A of the vehicle interior 205 and passenger seat 220B located at portion 425B of the vehicle interior 205. The set of passenger seats 225 can include passenger seat 225A located at portion 425A of the vehicle interior 205 and passenger seat 225B located at portion 425B of the vehicle interior 205.

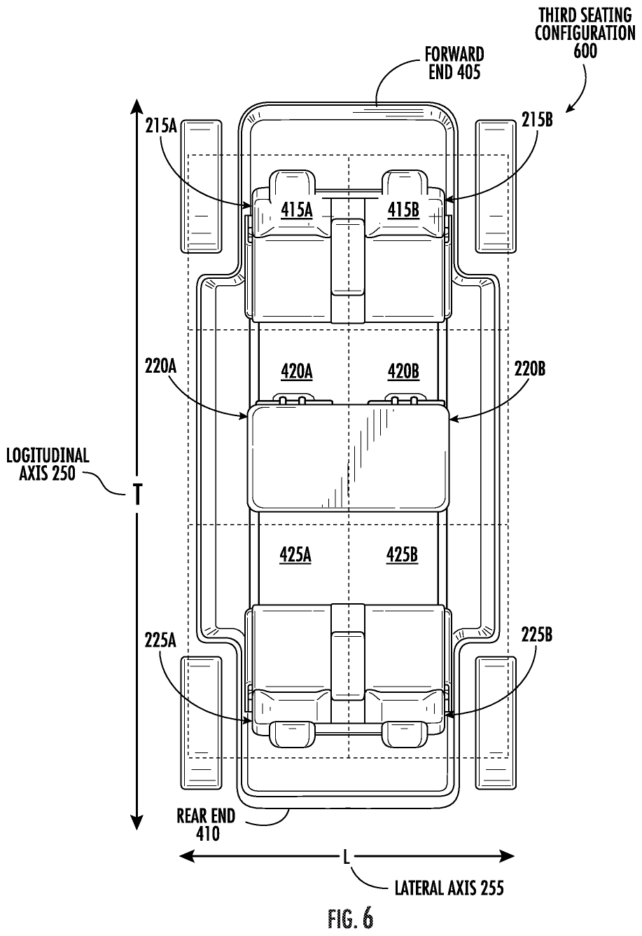

As another example, FIG. 6 depicts a top down view of a third example seating configuration 600 of an autonomous vehicle's interior according to example embodiments of the present disclosure. The third seating arrangement 600 can include a third set of one or more rows of seats 215, 220, 225. The third set of the one or more rows of seats 215, 220, 225 can include two rows of deployed passenger seats (e.g., rearward facing deployed seats 215 and/or forward facing deployed seats 225) and one row of tabletop seats (e.g., seats 220 in a stowed position 370). Each of the passenger seats 215A-B, 225A-B and the tabletop seats 220A-B can be positioned in a different portions of the vehicle interior 205. By way of example, the set of passenger seats 215 can include passenger seat 215A located at portion 415A of the vehicle interior 205 and passenger seat 215B located at portion 415B of the vehicle interior 205. The set of passenger seats 220 can include passenger seat 220A located at portion 420A of the vehicle interior 205 and passenger seat 220B located at portion 420B of the vehicle interior 205. The set of passenger seats 225 can include passenger seat 225A located at portion 425A of the vehicle interior 205 and passenger seat 225B located at portion 425B of the vehicle interior 205. The first row of passenger seats 215 can include one or more passenger seats 215A-B with a seating orientation directed towards the second end (e.g., rear end 410) of the vehicle. The third row of passenger seats 225 can include one or more passenger seats with a seating orientation directed towards the first end (e.g., forward end 405) of the vehicle, and the row of tabletop seats 220A-B can be placed between the first row of deployed seats 215A-B and the second row of deployed seats 225A-B such that passengers sitting in either row can use the row of tabletop seats 220A-B as a table.

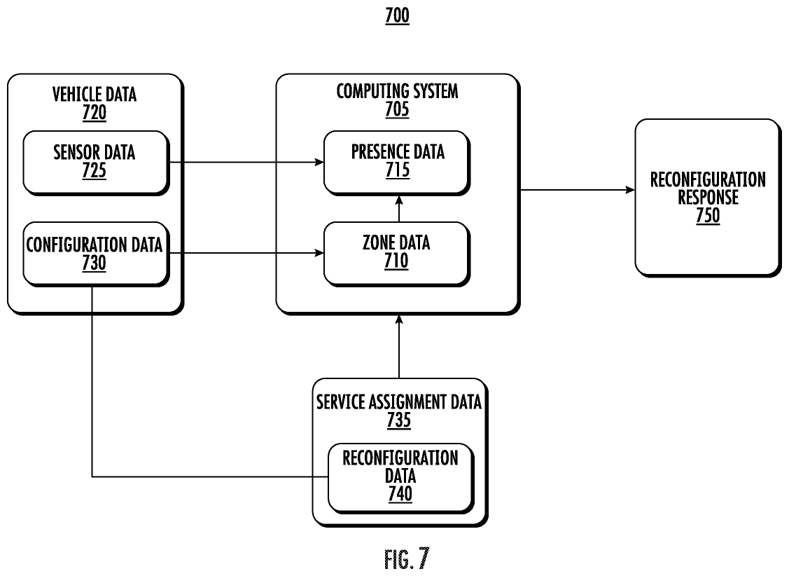

As described herein, a computing system (e.g., vehicle computing system, remote operations computing system, etc.) can obtain sensor data indicative of one or more object(s) and/or passenger(s) and determine whether a reconfiguration of the vehicle's interior from one configuration to another is appropriated based one or more impacted zones of an autonomous vehicle. For example, FIG. 7 depicts a dataflow diagram 700 for determining a reconfiguration response according to example embodiments of the present disclosure. As depicted, a computing system 705 can determine zone data 710 and/or presence data 715 based on vehicle data 720 and/or service assignment data 735. The vehicle data 720 can include at least one of sensor data 725 (e.g., the sensor data 116 and/or a portion of the sensor data 116, etc.) and/or configuration data 730. The service assignment data 735 can include reconfiguration data 740. The computing system can determine and/or initiate a reconfiguration response 750 based at least in part on the zone data 710 and/or the presence data 715.

More particularly, the computing system 705 (e.g., vehicle computing system 112, operations computing system 104, etc. of FIG. 1) can initiate the reconfiguration of the vehicle interior from any current interior arrangement (e.g., as indicated by the vehicle layout) to any reconfigured interior arrangement (e.g., as indicated by reconfiguration data 740) based on information indicative of the vehicle interior and the reconfiguration of the vehicle interior. For example, the computing system 705 can obtain vehicle data 720 indicative of the interior of the vehicle. The vehicle data 720 can include the sensor data 725 (e.g., sensor data 114 of FIG. 1) and/or configuration data 730. The configuration data 730 can be indicative of a current interior arrangement (e.g., a vehicle layout) of the vehicle interior.

For example, as discussed above, the vehicle interior of an autonomous vehicle can include a plurality of interior portions and one or more interior components (e.g., one or more passenger seats, tables, etc.). Each respective interior arrangement of a plurality of interior arrangements can be indicative of a placement of the one or more interior components on one or more respective portions of the plurality of interior portions. As an example, the plurality of interior components can be passenger seats, storage areas, tables, wheelchair supports, etc. The configuration data 730 can identify a current, preceding, and/or subsequent seating arrangement for an autonomous vehicle at a current time. For example, the configuration data 730 can include an indication of a current seating arrangement that identifies each of the plurality of interior portions of the autonomous vehicle and one or more interior components located on, coupled to, etc. one or more of the interior portions of the autonomous vehicle at the current time.

In addition, or alternatively, the configuration data 730 can include an indication of a preceding and/or subsequent seating arrangement that identifies each of the plurality of interior portions of the autonomous vehicle and one or more interior components located on, coupled to, etc. one or more of the interior portions of the autonomous vehicle at one or more times previous to the current time (e.g., one or more minutes, hours, days, etc. before the current time) and/or subsequent to the current time (e.g., one or more minutes, hours, days, etc. after the current time), respectively.

By way of example, the configuration data 730 can include a seating arrangement log identifying each of a plurality of different seating arrangements of a vehicle at one or more times preceding the current time. The seating arrangement log, for example, can be obtained, stored, and/or accessed to determine information for a vehicle such as whether a vehicle requires maintenance (e.g., based on a threshold number of reconfigurations, etc.), is capable of a seating arrangement (e.g., has been configured in a seating arrangement in the past, etc.), etc. Moreover, the configuration data 730 can identify one or more anticipated seating arrangements indicative of a predicted seating arrangement for a time subsequent to the current time. The anticipated seating arrangement can be determined, for example, based on service assignment data 735 indicative of a request for a transportation service at some time step (e.g., one or more minutes, hours, etc.) subsequent to the current time.

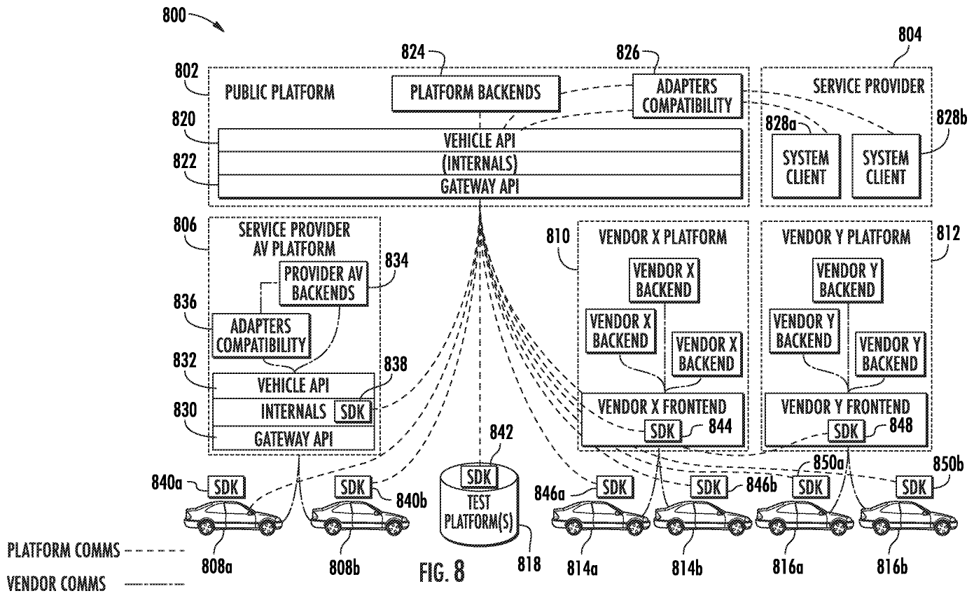

For example, a transportation service provider can receive a request for a transportation service. As an example, FIG. 8 depicts an example service infrastructure 800 according to example embodiments of the present disclosure. The service infrastructure 800 can include one or more components that are included in an operations computing system 104 for providing the type of vehicle services and control of the present disclosure.

As illustrated in FIG. 8, an example service infrastructure 800, according to example embodiments of the present disclosure, can include an application programming interface platform (e.g., public platform) 802, a service entity system 804, a service entity autonomous vehicle platform (e.g., private platform) 806, one or more service entity autonomous vehicles (e.g., first party autonomous vehicles in a service entity fleet) such as autonomous vehicles 808a and 808b, and one or more test platforms 818. For example, the service entity may own, lease, etc. a fleet of autonomous vehicles that can be managed by the service entity (e.g., its backend system clients) to provide one or more vehicle services. The autonomous vehicle(s) 808a, 808b utilized to provide the vehicle service(s) can be included in this fleet of the service entity. Additionally, the service infrastructure 800 can also be associated with and/or in communication with one or more third-party entity systems such as vendor platforms 810 and 812, and/or one or more third-party entity autonomous vehicles (e.g., in a third-party entity autonomous vehicle fleet) such as autonomous vehicles 814a, 814b, 816a, and 816b. For instance, the autonomous vehicle 814a, 814b, 816a, and 816b can be associated with a third party vehicle provider such as, for example, an individual, an original equipment manufacturer (OEM), a third party vendor, or another entity. These autonomous vehicles may be referred to as “third party autonomous vehicles.” Even though such an autonomous vehicle 814a, 814b, 816a, and 816b may not be included in the fleet of autonomous vehicles of the service entity, the service entity infrastructure 800 can include a platform that can allow the autonomous vehicle(s) 814a, 814b, 816a, and 816b associated with a third party to still be utilized to provide the vehicle services offered by the service entity, access the service entity's system clients, and/or the like.

The service infrastructure 800 can include a public platform 802 to facilitate vehicle services (e.g., provided via one or more system clients (828a, 828b) associated with a service entity operations computing system) between the service entity infrastructure system 804 (e.g., operations computing system 104, etc.) and vehicles (e.g., vehicle computing systems 112, etc.) associated with one or more entities (e.g., vehicles associated with the service entity (808a, 808b), vehicles associated with third-party entities (814a, 814b, 816a, 816b), etc.). For example, in some embodiments, the public platform 802 can provide access to services (e.g., associated with the service provider system 804) such as trip assignment services, routing services, supply positioning services, payment services, and/or the like.

The public platform 802 can include a gateway API (e.g., gateway API 822) to facilitate communication from the autonomous vehicles to the service entity infrastructure services (e.g., system clients 828a, 828b, etc.) and a vehicle API (e.g., vehicle API 820) to facilitate communication from the service entity infrastructure services (e.g., system clients 828a, 828b, etc.) to the vehicles (e.g., 808a, 808b, 814a, 814b, 816a, 816b). For example, the public platform 802, using the vehicle API 820, can query the vehicles (e.g., 808a, 808b, 814a, 814b, 816a, 816b) and/or third party systems/platforms to determine an availability (e.g., to accept a vehicle service assignment, vehicle operational capability, vehicle arrangement capability, etc.). The vehicles and/or other systems can transmit data (e.g., availability data, operational capability data, configuration data, etc.) to the public platform 802 using the gateway API 822.

In some embodiments, the public platform 802 can be a logical construct that contains all vehicle and/or service facing interfaces. The public platform 802 can include a plurality of backend services interfaces (e.g., public platform backend interfaces 824). Each backend interface 824 can be associated with at least one system client (e.g., service provider system 804 clients such as system clients 828a and 828b). A system client (e.g., 828a, 828b, etc.) can be the hardware and/or software implemented on a computing system (e.g., operations computing system of the service entity) that is remote from the vehicle and that provides a particular back-end service to a vehicle (e.g., scheduling of vehicle service assignments, routing services, payment services, user services, vehicle rating services, etc.). A backend interface 824 can be the interface (e.g., a normalized interface) that allows one application and/or system (e.g., of the autonomous vehicle) to provide data to and/or obtain data from another application and/or system (e.g., a system client). Each backend interface 824 can have one or more functions that are associated with the particular backend interface. A vehicle can provide a communication to the public platform 802 to call a function of a backend interface. In this way, the backend interface(s) 824 can be an external facing edge of the service entity infrastructure system 804 that is responsible for providing a secure tunnel for a vehicle and/or other system to communicate with a particular service provider system client (e.g., 828a, 828b, etc.) so that the vehicle and/or other system can utilize the backend service associated with that particular service entity system client (e.g., 828a, 828b, etc.), and vice versa.

In some embodiments, the public platform 802 can include one or more adapters 826, for example, to provide compatibility between one or more backend interfaces 824 and one or more service entity system clients (e.g., 828a, 828b, etc.). In some embodiments, the adapter(s) 826 can provide upstream and/or downstream separation between the service entity operations computing system 804 (e.g., operations computing system 104, system clients 828a, 828b, etc.) and the public platform 802 (e.g., backend interfaces 824, etc.). In some embodiments, the adapter(s) 826 can provide or assist with data curation from upstream services (e.g., system clients), flow normalization and/or consolidation, extensity, and/or the like.

The service infrastructure 800 can include a private platform 806 to facilitate service provider-specific (e.g., internal, proprietary, etc.) vehicle services (e.g., provided via one or more system clients (828a, 828b) associated with the service entity operations computing system (e.g., operations computing system 104, etc.) between the service entity infrastructure system 804 and vehicles associated with the service entity (e.g., vehicles 808a, 808b). For example, in some embodiments, the private platform 806 can provide access to service entity services that are specific to the service entity vehicle fleet (e.g., first party autonomous vehicles 808a and 808b) such as fleet management services, autonomy assistance services, reconfiguration services, and/or the like.

The private platform 806 can include a gateway API (e.g., gateway API 830) to facilitate communication from the vehicles 808a, 808b to one or more service entity infrastructure services (e.g., via the public platform 802, via one or more service entity autonomous vehicle backend interfaces 834, etc.) and a vehicle API (e.g., vehicle API 832) to facilitate communication from the service entity infrastructure services (e.g., via the public platform 802, via one or more service provider vehicle backend interfaces 834, etc.) to the vehicles 808a, 808b. The private platform 806 can include one or more backend interfaces 834 associated with at least one system client (e.g., service provider vehicle-specific system clients, such as fleet management, autonomy assistance, etc.). In some embodiments, the private platform 806 can include one or more adapters 836, for example, to provide compatibility between one or more service entity vehicle backend interfaces 834 and one or more private platform APIs (e.g., vehicle API 832, gateway API 830).

In some embodiments, the service infrastructure 800 can include a test platform 818 for validating and vetting end-to-end platform functionality, without use of a real vehicle on the ground. For example, the test platform 818 can simulate trips with human drivers and/or support fully simulated trip assignment and/or trip workflow capabilities.

The service infrastructure 800 can be associated with and/or in communication with one or more third-party entity systems, such as third-party entity (e.g., Vendor X) platform 810 and third-party entity (e.g., Vendor Y) platform 812, and/or one or more third-party entity vehicles (e.g., in a third-party entity vehicle fleet) such as third-party vehicles 814a, 814, 816a, and 816b. The third-party entity platforms 810, 812 can be distinct and remote from the service provider infrastructure and provide for management of vehicles associated with a third-party entity fleet, such as third-party entity (e.g., Vendor X) vehicles 814a, 814b and third-party entity (e.g., Vendor Y) vehicles 816a, 816b. The third-party entity (e.g., Vendor X) platform 810 and third-party entity (e.g., Vendor Y) platform 812, and/or third-party entity (e.g., Vendor X) vehicles 814a, 814b and third-party entity (e.g., Vendor Y) vehicles 816a, 816b can communicate with the service entity operations computing system 804 (e.g., system clients, operations computing system 104, etc.) via the public platform 802 to allow the third-party entity platforms and/or vehicles to access one or more service entity infrastructure services (e.g., trip services, routing services, payment services, user services, etc.).

The service infrastructure 800 can include a plurality of software development kits (SDKs) (e.g., set of tools and core libraries), such as SDKs 838, 840a, 840b, 842, 844, 846a, 846b, 848, 850a, and 850b, that provide access to the public platform 802 for use by both the service provider autonomous vehicles (808a, 808b) and the third-party entity vehicles (814a, 814b, 816a, 816b). In some implementations, all external communication with the platforms can be done via the SDKs. For example, the provider entity infrastructure can include both a public SDK and a private SDK and specific endpoints to facilitate communication with the public platform 802 and the private platform 806, respectively. In some embodiments, the service entity vehicle fleet (e.g., vehicle 808a, 808b) and/or test platform 818 can use both the public SDK and the private SDK, whereas the third-party entity autonomous vehicles (vehicle 814a, 814b, 816a, 816b) can use only the public SDK and associated endpoints. In some implementations, the SDKs can provide a single entry point into the service entity infrastructure (e.g., public platform 802, etc.), which can improve consistency across both the service provider fleet and the third-party entity fleet(s). As an example, a public SDK can provide secured access to the public platform 802 by both service entity vehicles and third-party entity (and/or systems) and access to capabilities such as trip assignment, routing, onboarding new vehicles, supply positioning, monitoring and statistics, a platform sandbox (e.g., for integration and testing), and/or the like. The private SDK can be accessed by the service entity vehicles and provide access to capabilities such as remote assistance, vehicle management, operational data access, fleet management, and/or the like.

As described herein, an operations computing system (e.g., service entity system 804, operations computing system 104, etc.) associated with the transportation service provider can receive a request for a transportation service. The request can include a service type (e.g., pooling type, premium type, etc.), a number of passengers, one or more accommodations, a pick-up location, a destination location, and/or any other information related to a transportation service. For example, the operations computing system can obtain a transportation service request from a user of the transportation service provider. The transportation service request can include service request data indicative of at least an origin location and a number of passengers.

The operations computing system can determine whether a reconfiguration is required to complete the service request based on the service request data and/or the configuration data associated with the autonomous vehicle. For example, the operations computing system can determine a reconfigured interior arrangement for servicing the transportation request based, at least in part, on the number of passengers and/or one or more other factors associated with the transportation request. The reconfigured interior arrangement can be determined from a plurality of predefined interior arrangements such as, for example, the first interior arrangement 400 of FIG. 4, the second interior arrangement 500 of FIG. 5, and/or the third interior arrangement 600 of FIG. 5 provided as examples herein. Each predefined interior arrangement can indicate a placement and/or orientation of one or more interior components of a vehicle interior on one or more interior portions of the vehicle interior.

In some implementations, the operations computing system can search for a vehicle (e.g., from vehicles 808a-b, 814a-b, 816a-b, etc.) capable of completing the service request (e.g., based on a vehicle location, availability, configuration data, etc.). In some implementations, the operations computing system can preferably select a vehicle capable of completing the transportation service with a current interior arrangement that is the same as the reconfigured interior arrangement. For example, the operations computing system can obtain vehicle data including vehicle location data indicative of a geographic location of the one or more vehicles (e.g., vehicles 208a, 208b, etc.) associated with the service entity system 804 (and/or one or more third party autonomous vehicles 814a, 814b, 816a, and 816b) and configuration data indicative of a respective current interior arrangement associated with each respective vehicle of the one or more vehicles. The operations computing system can select a vehicle from the one or more autonomous vehicles based, at least in part, on the vehicle data, the reconfigured interior arrangement for servicing the transportation service request, and the origin location. For example, the operations computing system can balance the cost of reconfiguring the interior arrangement of a vehicle with an estimated distance of one or more vehicle(s) from an origin location of the transportation request.

Turning back to FIG. 7, in some implementations, the operations computing system can select an autonomous vehicle that requires a reconfiguration of its interior to satisfy the transportation request. In response, the operations computing system can determine service assignment data 735 for the selected vehicle based, at least in part, on the reconfigured interior arrangement (e.g., reconfiguration data 740, etc.) and the data indicative of the current interior arrangement associated with the vehicle (e.g., configuration data 730). The service assignment data 735 can include service request data (e.g., an origin location, number of passengers, etc.) and vehicle reconfiguration data 740. The vehicle reconfiguration data 740 can include an interior arrangement of a plurality of vehicle interior arrangements that is different than the current vehicle interior arrangement of the autonomous vehicle. The operations computing system can provide the service assignment data 735 (e.g., service request data, vehicle reconfiguration data 740, etc.) to the autonomous vehicle and/or a computing system associated with the autonomous vehicle (e.g., computing system 705, vehicle computing system 112, etc.)

In addition, or alternatively, the operations computing system can provide for fleet-wide reconfigurations by providing the vehicle reconfiguration data 740 to a plurality of autonomous vehicles. For instance, the operations computing system can determine that a plurality of vehicles can be reconfigured based on one or more external factors (e.g., demand curve matching, load balancing, high capacity incentivization in peak demand times/locations, emergency evacuation situations (e.g., due to weather, etc.), etc.). For instance, the operations computing system can determine, based on a number of collected service requests, one or more environmental factors (e.g., emergency weather conditions, etc.), that an interior configuration can be beneficial for a number of autonomous vehicles in one or more similar geographic regions and/or at one or more different times. For example, the operations computing system can determine that an entire fleet of autonomous vehicles can be reconfigured in the same manner based at least in part on the service request data included in the service request, environmental data, etc. As another example, the operations computing system can determine an interior configuration that can be beneficial for a number of autonomous vehicles located in a certain geographic area (e.g., a high-density urban area, a low-density rural area, etc.) based on one or more current events (e.g., high density events such as a sporting event, music festival, etc.), one or more traffic patterns (e.g., high density traffic after work hours, etc.), and the like. In such a case, the operations computing system can provide the vehicle reconfiguration data 740 to each of the number of autonomous vehicles.

As an example, the operations computing system can determine, from a number of service requests, environmental data, traffic data, current event data, etc., a preferred seat configuration that maximizes a number of passengers (e.g., to lower an associated ride cost, increase the number of transported passengers over time (e.g., to timely evacuate persons from an area, etc.), etc.) for one or more autonomous vehicles in a geographic region at one or more times. In response, the operations computing system can provide vehicle reconfiguration data 740 to each of the one or more autonomous vehicles in the geographic area to reconfigure the autonomous vehicles to a seating configuration that maximizes a number of passengers of the autonomous vehicle. In such fashion, the operations computing system can determine a fleet-wide configuration for an entire fleet of autonomous vehicles and/or a subset of a fleet of autonomous vehicles. In this manner, the operations computing system can cause the fleet and/or the subset of the fleet of vehicles to reconfigure concurrently based on market demand, collated service request data, one or more emergency situations, and/or any other external factor affecting the transfer needs of passengers.

In this way, vehicle reconfiguration data 740 indicative of a reconfigured interior arrangement for a vehicle interior of the autonomous vehicle can be obtained. The reconfiguration data 740 can be indicative of a vehicle reconfiguration in which one or more components within the interior of a vehicle are rearranged to define another interior arrangement. For instance, the reconfiguration data 740 can include an adjustment to at least one of a position or orientation of the plurality of seats within the vehicle interior and/or a position or orientation of the one or more storage areas within the vehicle interior. The reconfigured interior arrangement can be different from a current interior arrangement of the vehicle interior.

The computing system 705 can determine one or more zones (e.g., zone data 710) of the vehicle interior based, at least in part, on the vehicle reconfiguration data 740 and the configuration data 730. The one or more zones can include a portion of the vehicle. Each zone, for example, can include a portion of the vehicle classified based on the impact of an interior reconfiguration on the portion of the vehicle. By way of example, the one or more zones can include at least one impacted zone. The at least one impacted zone can include a portion of the vehicle that is classified as “impacted” by a reconfiguration from a current interior arrangement to a reconfigured interior arrangement, as further described herein.

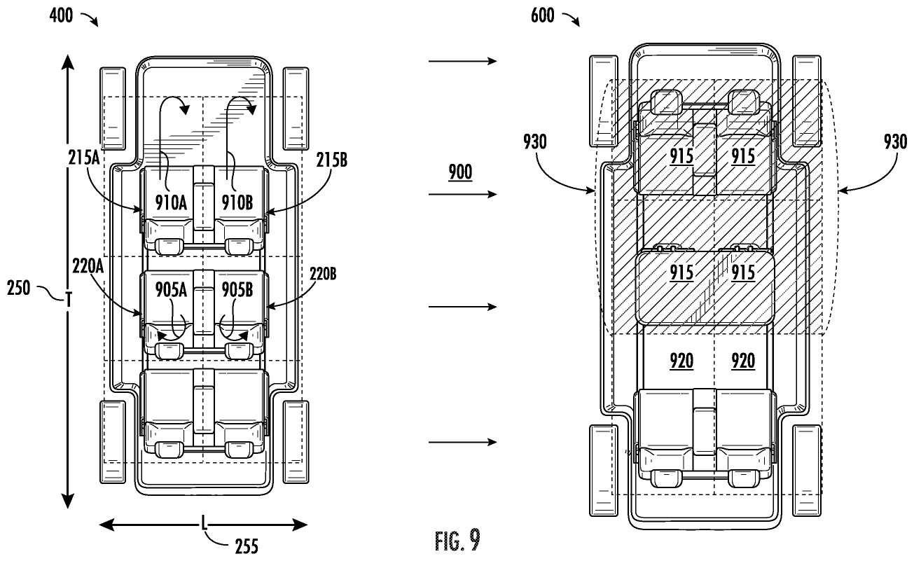

By way of example, FIG. 9 depicts a top down view of an example reconfiguration between two example seating configurations according to example embodiments of the present disclosure. More particularly, FIG. 9 depicts an interior reconfiguration from a current interior arrangement that is in a first interior arrangement 400 of FIG. 4 to a reconfigured interior arrangement that is in a third interior arrangement 600 of FIG. 6. To reconfigure (at 900) the interior arrangement from the first interior arrangement 400 to the third interior arrangement 600, the second passenger seats 220A-B can be configured to pivot (at 905A-B respectively) inward to form a table (in the manner described herein). In addition, first passenger seats 215A-B at a first orientation can be configured to slide (at 910A-B respectively) along the longitudinal axis 250 and pivot to a second orientation (in the manner described herein). Third passenger seats 225A-B can remain unmoved.

In this example, the portions of the vehicle within which a positional and/or orientational change of a passenger seat occurs can be determined as an impacted zone 915. For instance, impacted zones 915 can include the portions within which seats 220A-B and 215A-B are positioned while in the first interior arrangement 400 and the third interior arrangement 600. The portions of the vehicle within which the position and/or the orientation of a passenger seat is not changed can be determined as clear zones 920. For instance, clear zones 920 can include the portions within which seats 225A-B are positioned while in both the first interior arrangement 400 and the third interior arrangement 600.

The zone(s) 915 and 920 can be predetermined and/or dynamically determined. For example, the zone(s) of the vehicle interior can be predetermined for the autonomous vehicle based on each possible reconfiguration of the vehicle's interior. For example, the computing system 705 can include and/or have access to a vehicle zone database. The vehicle zone database can include a plurality of classifications (e.g., impacted, clear, in-between, etc.) for each portion of the autonomous vehicle based on a reconfiguration from each pair (e.g., one interior arrangement to another interior arrangement) of predefined interior arrangement. In some implementations, the computing system 705 can determine the one or more zones by matching the current interior arrangement 400 and the reconfigured interior arrangement 600 of the reconfiguration data to a pair of interior arrangements of the vehicle zone database.

In addition, or alternatively, the computing system can dynamically determine the one or more zones. For instance, the computing system can identify one or more affected components of the vehicle interior that can move during the reconfiguration and determine the one or more zones based on the portions of the vehicle interior on which the one or more affected components are currently and/or predicted to be placed. By way of example, as discussed in further detail below, the computing system can determine an impact level for each portion of the autonomous vehicle based on the one or more affected components and determine the one or more zones based on the impact level.

The one or more zones can include one or more impacted zones 915 (e.g., stay out zones, hazard zones, etc.), one or more clear zones 920, and/or one or more in-between zones 930. The one or more impacted zones 915, for example, can be indicative of one or more interior portions of the vehicle interior associated with a high impact level (e.g., high likelihood that the portion will be affected by a reconfiguration). For instance, the high impact level can be above an impact threshold level (e.g., over 50% chance that the portion will be affected by the reconfiguration). The one or more clear zones 920 can be indicative of one or more interior portions associated with a low impact level (e.g., low likelihood that the portion will be affected by the reconfiguration). For instance, the low impact level can be below a clear threshold (e.g., under a 50% chance that the portion will be affected by the reconfiguration). The one or more in-between zones 930 can include an area surrounding at least one impacted zone. For example, the at least one impacted zone can be associated with a proximity threshold that identifies an area surrounding the at least one impacted zone. The proximity threshold of the at least one impacted zone can be indicative of one or more interior and/or exterior portions of the autonomous vehicle associated with a proximity impact level between the clear threshold level and the impact threshold level (e.g., a 50% chance that the portion will be affected by the reconfiguration). For example, the impacted zone can include a portion of the vehicle interior directly impacted by a reconfiguration and the proximity threshold can include a safe distance from the impacted portion of the vehicle interior.

Turning back to FIG. 7, in some implementations, the computing system 705 can determine zone data 710 for the one or more zone(s) by assigning an impact level to a plurality of portions of the vehicle interior. For example, the computing system 705 can assign an impact level to one or more portions of the vehicle interior. The computing system 705 can determine the impact level for one or more of the plurality of interior portions based, at least in part, on the reconfigured interior arrangement (e.g., as indicated by the reconfiguration data 740) and the current interior arrangement (e.g., as indicated by the reconfiguration data 740, configuration data 730, etc.). The impact level for a respective interior portion, for example, can be indicative of an estimated impact on the respective interior portion during the vehicle reconfiguration. For example, the impact level can be determined based on the one or more components of the vehicle interior that will be moved during the reconfiguration. For example, as depicted in FIG. 9, an interior portion where a seat that is to be moved during reconfiguration is currently placed, where the seat will be moved after reconfiguration, and/or the area in between can be associated with a higher impact level (e.g., above an impact threshold). In addition, or alternatively, an interior portion where a seat is located that is not expected to move during a reconfiguration can be associated with a lower impact level (e.g., under a clear threshold). In some implementations, the computing system 705 can determine a total impact for the autonomous vehicle during of a reconfiguration operation. The total impact can be based on the impact level to one or more interior portions of the vehicle interior.

As described herein, a computing system 705 can obtain sensor data 725 indicative of the one or more objects and/or passengers associated with the autonomous vehicle. The computing system 705 can determine presence data 715 based on the sensor data 725 and/or the zone data 710 (e.g., one or more zones of the autonomous vehicle). The presence data 715, for example, can be indicative of a position of an object with respect to the at least one impacted zone. For example, the presence data 715 can identify a current and/or predicted location of an object relative to the impacted zone(s) of the autonomous vehicle. By way of example, the presence data 715 can be indicative of a predicted position of the object and/or passenger with respect to at least one impacted zone. In this manner, the computing system 705 can detect passenger(s) (and/or object(s)) in or in the process of entering a vehicle interior before reconfiguring the vehicle interior. As used herein, for example, one or more objects can include one or more users associated with the autonomous vehicle for a requested vehicle service and/or one or more items associated with the autonomous vehicle for a requested vehicle service.

The computing system 705 can determine a potential impact of the reconfigured interior arrangement on the one or more objects associated with the autonomous vehicle based at least in part on the vehicle reconfiguration data 740 and the sensor data 725 (e.g., presence data 715). To do so, the computing system 705 can obtain and/or determine zone data 710 indicative of the one or more zones and determine that at least one of the zones is an impacted zone based on the vehicle interior arrangement (e.g., in the manner described herein). The computing system 705 can determine the current and/or predicted location of the object(s) with respect to the one or more zones associated with the autonomous vehicle and determine whether at least one object is currently located and/or is predicted to be located within an impacted zone based on the zone data 710 and the presence data 715. For example, the computing system 705 can determine that the at least one object is located within at least one impacted zone based at least in part on the current position of the object (e.g., as indicated by the presence data 715). In addition, or alternatively, the computing system 705 can determine that the at least one object is predicted to be located within the at least one impacted zone based at least in part on the predicted position (e.g., as indicated by the presence data 715) of the object.

The computing system 705 (e.g., vehicle computing system 112 of FIG. 1, etc.) can initiate a vehicle reconfiguration response 750 based at least in part on the vehicle reconfiguration data 740 and the potential impact of the reconfigured interior arrangement on one or more objects associated with the autonomous vehicle. For example, the vehicle reconfiguration response 750 can include initiating a vehicle reconfiguration, initiating one or more reconfiguration prompts, and/or rejecting a vehicle reconfiguration. By way of example, the computing system 705 can initiate the vehicle reconfiguration in the event no objects are present within and/or proximate to an impacted zone of the autonomous vehicle. In addition, or alternatively, the computing system 705 can initiate one or more reconfiguration prompts and/or reject a vehicle reconfiguration in the event that at least one object is present within and/or proximate to an impacted zone of the autonomous vehicle.

As an example, the computing system 705 can determine that at least one object of the one or more objects is or is predicted to be located outside of the proximity threshold associated with the at least one impacted zone based on the presence data 715. The computing system 705 can initiate a vehicle reconfiguration of the vehicle interior in response to determining that the at least one object of the one or more objects is or is predicted to be located outside of the proximity threshold. For example, the computing system 705 can activate one or more mechanisms, actuators, etc. to move one or more seats, partitions, etc. within the interior of the vehicle to obtain the reconfigured vehicle arrangement specified by the reconfiguration data 740. By way of example, the vehicle reconfiguration of the vehicle interior can include a transition from the placement of the one or more interior components at one or more current portions of the plurality of interior portions in accordance with the current interior arrangement to one or more assigned portions of the plurality of interior portions in accordance with the reconfigured interior arrangement.

As another example, the computing system 705 can determine that at least one object of the one or more objects is within the proximity threshold associated with the at least one impacted zone based, at least in part, on the presence data 715. The computing system 705 can initiate a reconfiguration prompt and/or reject the vehicle reconfiguration in response to determining that the at least one object of the one or more objects is within the proximity threshold. By way of example, the computing system 705 can reject the vehicle reconfiguration in response to determining that the at least one object of the one or more object is within the proximity threshold. In such a case, the vehicle computing system 705 can communicate rejection data to an operations computing system indicating that the vehicle may not perform the vehicle reconfiguration. The operations computing system can receive the rejection data and, in response, select another vehicle from the one or more autonomous vehicles to complete the transportation service.

In addition, or alternatively, the operations computing system can determine one or more actions for the vehicle to enable the reconfiguration. For example, the operations computing system can alter a route of the vehicle. The altered route can include one or more intermediate stops. For example, an intermediate stop can include a maintenance location where the vehicle interior can be inspected (e.g., to identify and remove any obstruction preventing a vehicle reconfiguration). In some implementations, the intermediate stop(s) can include intermediate drop-off locations where the vehicle can drop off one or more passengers within the vehicle interior (e.g., to clear any passengers from an impacted area). For example, the altered route can prioritize one or more intermediate drop-off locations over the pick-up location for a transportation services request to clear one or more portions of the vehicle interior. In this manner, the vehicle can be instructed to travel along the altered route and initiate the vehicle reconfiguration before arriving at the pick-up location (e.g., after the one or more impacted zone(s) of the vehicle interior are clear of any objects and/or passengers).

In some implementations, the computing system 705 can issue a reconfiguration prompt. The reconfiguration prompt, for example, can include a sensory prompt (e.g., visual prompt via a user interface, a tactile prompt via one or more tactile devices within the vehicle, auditory prompt via one or more speakers within the vehicle, etc.) provided to one or more passengers associated with the vehicle. The prompt can be indicative of the reconfiguration. For example, the prompt can identify the one or more impacted zones of the vehicle and/or one or more hazard zones (e.g., areas directly and/or indirectly impacted by the reconfiguration). In addition, the prompt can identify one or more clear areas. For example, a prompt can include a request for the passenger to move to a clear area, move away from an impacted area, exit the vehicle, move an object (e.g., luggage, etc.) from an impacted area to a clear area, avoid/delay boarding the vehicle, etc.

In some implementations, the computing system 705 can monitor the interior of the vehicle during an interior reconfiguration. For instance, the computing system 705 can be configured to continuously collect sensor data 725 indicative of the interior of the vehicle during the interior reconfiguration. The sensor data 725 can include the data described above. In addition, or alternatively, the sensor data 725 can include component data indicative a state of one or more moveable components of the vehicle interior. For instance, the sensors can include a sensor on each individual actuator, motor, and/or any other mechanism configured to move a component within the vehicle interior. The component data can be indicative of one or more torque spikes and/or other mechanical health information. The computing system 705 can be configured to halt a reconfiguration in the event that the one or more sensors detect an abnormality associated with the operation of any of the one or more moveable components. In some implementations, the computing system 705 can reject the vehicle reconfiguration, in the manner described above, in response to halting the reconfiguration.

In addition, the computing system 705 can obtain, via the one or more vehicle sensors, second presence data indicative of a second proximity of the object(s) to the at least one impacted zone during the reconfiguration of the vehicle interior. The second presence data can be different than the first presence data. For example, the second presence data can include the first presence data updated during the reconfiguration. The computing system 705 can be configured to halt a reconfiguration, issue a reconfiguration prompt, and/or reject a reconfiguration, in the manner described above, in the event that the second presence data is indicative of an object within a proximity to one or more impacted zones.

In some implementations, the computing system 705 can monitor the reconfiguration to confirm that the vehicle reconfiguration has completed. For example, the computing system 705 can determine that the one or more interior components of the vehicle interior are arranged in accordance with the reconfigured interior arrangement. In some implementations, the computing system 705 can generate a confirmation prompt indicating that the vehicle reconfiguration is completed. The computing system 705 can communicate, via one or more output devices, the confirmation prompt to the one or more passengers of the autonomous vehicle (e.g., in the manner described above with reference to the reconfiguration prompts).

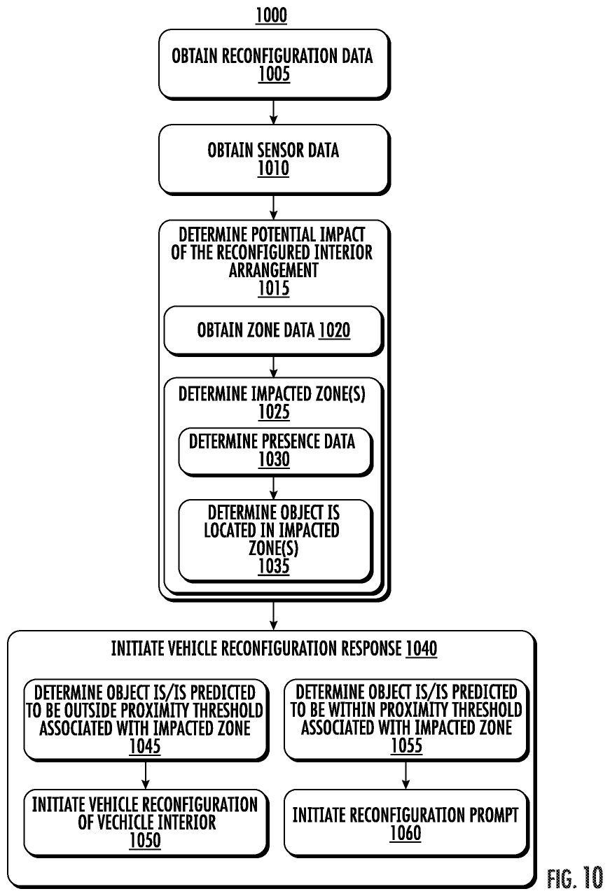

Turning to FIG. 10, FIG. 10 depicts a flowchart of a method 1000 for initiating a reconfiguration response according to example embodiments of the present disclosure. One or more portion(s) of the method 1000 can be implemented by a computing system that includes one or more computing devices such as, for example, the computing systems described with reference to the other figures (e.g., the computing system 705, operations computing system 104, vehicle computing system 112, etc.). Each respective portion of the method 1000 can be performed by any (or any combination) of one or more computing devices. Moreover, one or more portion(s) of the method 1000 can be implemented as an algorithm on the hardware components of the device(s) described herein (e.g., as in FIGS. 1, 11, 12, etc.), for example, to initiate a reconfiguration response. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. FIG. 10 is described with reference to elements/terms described with respect to other systems and figures for exemplary illustrated purposes and is not meant to be limiting. One or more portions of method 1000 can be performed additionally, or alternatively, by other systems.

At 1005, the method 1000 can include obtaining reconfiguration data. For example, a computing system (e.g., computing system 705, vehicle computing system 112, etc.) can obtain vehicle reconfiguration data indicative of a reconfigured interior arrangement for a vehicle interior of an autonomous vehicle. The reconfigured interior arrangement can be different from a current interior arrangement of the vehicle interior. By way of example, the vehicle interior can include a plurality of seats and one or more storage areas. The reconfiguration data can include an adjustment to at least one of: (i) a position or orientation of the plurality of seats within the vehicle interior; or (ii) a position or orientation of the one or more storage areas within the vehicle interior.

At 1010, the method 1000 can include obtaining sensor data. For example, a computing system (e.g., computing system 705, vehicle computing system 112, etc.) can obtain sensor data indicative of one or more objects associated with the autonomous vehicle. The one or more objects can include one or more users associated with the autonomous vehicle for a requested vehicle service and/or one or more items associated with the autonomous vehicle for the requested vehicle service. The sensor data can include at least one of interior image data, exterior image data, and/or tactile data.

At 1015, the method 1000 can include determining a potential impact of the reconfigured interior arrangement. For example, a computing system (e.g., computing system 705, vehicle computing system 112, etc.) can determine a potential impact of the reconfigured interior arrangement on the one or more objects associated with the autonomous vehicle based at least in part on the vehicle reconfiguration data and the sensor data.

To do so, at (1020), the method 1000 can include obtaining zone data. For example, a computing system (e.g., computing system 705, vehicle computing system 112, etc.) can obtain data indicative of one or more zones of the vehicle interior. For instance, the one or more zones of the vehicle interior can be predetermined for the autonomous vehicle. In addition, or alternatively, the computing system can determine the one or more zones of the vehicle interior based on the vehicle reconfiguration data. The one or more zones can include one or more clear zones indicative of one or more interior portions of the vehicle interior associated with a low impact level. And, the one or more zones can include one or more impacted zones including the impacted zone. The one or more impacted zones can be indicative of one or more interior portions of the vehicle interior associated with a high impact level.

In addition, at (1025), the method 1000 can include determining impacted zone(s). For example, a computing system (e.g., computing system 705, vehicle computing system 112, etc.) can determine that at least one of the zones is an impacted zone based at least in part on the vehicle reconfiguration data. The impacted zone can be affected by the reconfigured interior arrangement. In some implementations, the impacted zone can be associated with a proximity threshold that identifies an area surrounding the impacted zone.

At 1030, the method 1000 can include determining presence data. For example, a computing system (e.g., computing system 705, vehicle computing system 112, etc.) can determine, based at least in part on the sensor data, presence data indicative of a position of an object with respect to the impacted zone. For example, at (1035), the method 1000 can include determining that an object is located in an impacted zone. For instance, a computing system (e.g., computing system 705, vehicle computing system 112, etc.) can determine that the object is located within the impacted zone based at least in part on the presence data.

In addition, or alternatively, the computing system can determine, based at least in part on the sensor data, presence data indicative of a predicted position of an object with respect to the impacted zone. The computing system can determine that the object is to be located within the impacted zone based at least in part on the predicted position of the object. By way of example, the computing system can utilize a prediction system (e.g., prediction system 126 of FIG. 1) and/or one or more components (e.g., functions, machine-learned prediction models, etc.) of the prediction system to determine a trajectory (e.g., path over time) for a passenger associated with the vehicle. The trajectory can be indicative of a path travelling towards the vehicle, for example, to board the vehicle. In addition, or alternatively, the trajectory can be indicative of a path of the passenger within the vehicle (e.g., from one seat to another, etc.). The computing system can determine that an object is to be located in the impacted zone based on the trajectory.

At 1040, the method 1000 can include initiating a vehicle reconfiguration response. For example, a computing system (e.g., computing system 705, vehicle computing system 112, etc.) can initiate a vehicle reconfiguration response based at least in part on the vehicle reconfiguration data and the potential impact of the reconfigured interior arrangement on the one or more objects associated with the autonomous vehicle.

For example, at (1045), the method 1000 can include determining that an object is/is predicted to be outside of a proximity threshold associated with an impacted zone. For example, a computing system (e.g., computing system 705, vehicle computing system 112, etc.) can determine that at least one object of the one or more objects is or is predicted to be located outside of the proximity threshold associated with the impacted zone.

In response, at (1050), the method 1000 can include initiating the vehicle reconfiguration of the vehicle interior. For example, a computing system (e.g., computing system 705, vehicle computing system 112, etc.) can initiate a vehicle reconfiguration of the vehicle interior in response to determining that the at least one object of the one or more objects is or is predicted to be located outside of the proximity threshold.

In addition, or alternatively, at (1055), the method 1000 can include determining that an object is/is predicted to be within a proximity threshold associated with an impacted zone. For example, a computing system (e.g., computing system 705, vehicle computing system 112, etc.) can determine that at least one object of the one or more objects is or is predicted to be within the proximity threshold associated with the impacted zone.

In response, at (1060), the method 1000 can include initiating a reconfiguration prompt. For example, a computing system (e.g., computing system 705, vehicle computing system 112, etc.) can initiate a reconfiguration prompt in response to determining that the at least one object of the one or more objects is within the proximity threshold. For instance, the computing system can generate a reconfiguration prompt and communicate, via one or more output devices, the reconfiguration prompt to one or more passengers of the vehicle. The reconfiguration prompt, for example, can include at least one of a visual cue, an auditory cue, or a tactile cue. As an example, the reconfiguration prompt can include a request for the one or more passengers to vacate the at least one impacted zone of the vehicle interior.

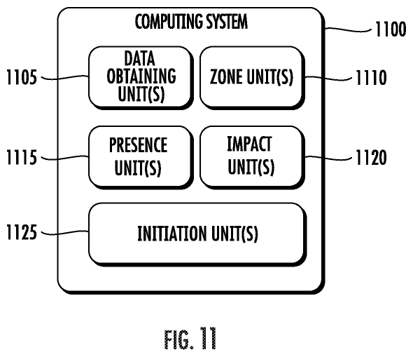

Turning to FIG. 11, various means can be configured to perform the methods and processes described herein. For example, a computing system 1100 can include data obtaining unit(s) 1105, zone unit(s) 1110, presence unit(s) 1115, impact unit(s) 1120, initiation unit(s) 1125 and/or other means for performing the operations and functions described herein. In some implementations, one or more of the units may be implemented separately. In some implementations, one or more units may be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry, for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means (e.g., data obtaining unit(s) 1105, etc.) can be configured to obtain vehicle reconfiguration data indicative of a reconfigured interior arrangement for a vehicle interior of an autonomous vehicle. The reconfigured interior arrangement can be different from a current interior arrangement of the vehicle interior. In addition, the means (e.g., data obtaining unit(s) 1105, etc.) can be configured to obtain sensor data indicative of one or more objects associated with the autonomous vehicle.

The means (e.g., zone unit(s) 1110, etc.) can be configured to determine one or more zones of the vehicle interior based, at least in part, on the vehicle reconfiguration data. The one or more zones can include at least one impacted zone. The means (e.g., presence unit(s) 1115, etc.) can be configured to determine first presence data based at least in part on the sensor data. The first presence data can indicate at least one of a first current location or first predicted location of the one or more objects. For instance, the first presence data can indicate at least one or a first current location or first predicted location of the one or more object with respect to the at least one impacted zone.

The means (e.g., impact unit(s) 1120, etc.) can be configured to determine a potential impact of the reconfigured interior arrangement on the one or more objects associated with the autonomous vehicle based at least in part on the vehicle reconfiguration data and the sensor data. In addition, the means (e.g., impact unit(s) 1120, etc.) can be configured to determine a potential impact of the reconfigured interior arrangement on the one or more objects associated with the autonomous vehicle based at least in part on the vehicle reconfiguration data and the presence data. The means (e.g., initiation unit(s) 1135, etc.) can be configured to initiate a vehicle reconfiguration response based at least in part on the vehicle reconfiguration data and the potential impact of the reconfigured interior arrangement on the one or more objects associated with the autonomous vehicle.

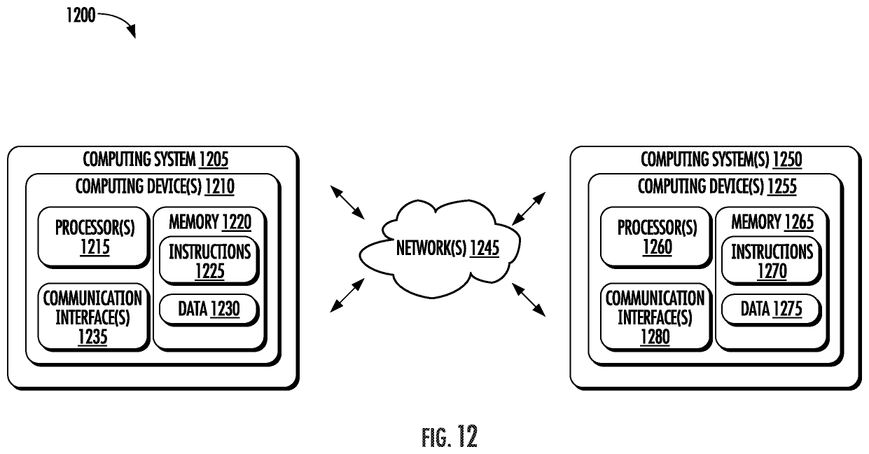

FIG. 12 depicts example system components of an example system 1200 according to example embodiments of the present disclosure. The example system 1200 can include the computing system 1205 (e.g., a vehicle computing system 112, computing system 705, etc.) and the computing system(s) 1250 (e.g., operations computing system 104, etc.), etc. that are communicatively coupled over one or more network(s) 1245.

The computing system 1205 can include one or more computing device(s) 1210. The computing device(s) 1210 of the computing system 1205 can include processor(s) 1215 and a memory 1220. The one or more processors 1215 can be any suitable processing device (e.g., a processor core, a microprocessor, an ASIC, a FPGA, a controller, a microcontroller, etc.) and can be one processor or a plurality of processors that are operatively connected. The memory 1220 can include one or more non-transitory computer-readable storage media, such as RAM, ROM, EEPROM, EPROM, one or more memory devices, flash memory devices, etc., and combinations thereof.

The memory 1220 can store information that can be accessed by the one or more processors 1215. For instance, the memory 1220 (e.g., one or more non-transitory computer-readable storage mediums, memory devices) can include computer-readable instructions 1225 that can be executed by the one or more processors 1215. The instructions 1225 can be software written in any suitable programming language or can be implemented in hardware. Additionally, or alternatively, the instructions 1225 can be executed in logically and/or virtually separate threads on processor(s) 1215.

For example, the memory 1220 can store instructions 1225 that when executed by the one or more processors 1215 cause the one or more processors 1215 to perform operations such as any of the operations and functions for which the computing systems (e.g., computing system 705, vehicle computing system 112) are configured, as described herein.

The memory 1220 can store data 1230 that can be obtained, received, accessed, written, manipulated, created, and/or stored. The data 1230 can include, for instance, vehicle data, sensor data, configuration data, service assignment data, reconfiguration data, presence data, zone data and/or other data/information described herein. In some implementations, the computing device(s) 1210 can obtain from and/or store data in one or more memory device(s) that are remote from the computing system 1205 such as one or more memory devices of the computing system 1250.

The computing device(s) 1210 can also include a communication interface 1235 used to communicate with one or more other system(s) (e.g., computing system 1250). The communication interface 1235 can include any circuits, components, software, etc. for communicating via one or more networks (e.g., 1245). In some implementations, the communication interface 1235 can include for example, one or more of a communications controller, receiver, transceiver, transmitter, port, conductors, software and/or hardware for communicating data/information.

The computing system 1250 can include one or more computing devices 1255. The one or more computing devices 1255 can include one or more processors 1260 and a memory 1265. The one or more processors 1260 can be any suitable processing device (e.g., a processor core, a microprocessor, an ASIC, a FPGA, a controller, a microcontroller, etc.) and can be one processor or a plurality of processors that are operatively connected. The memory 1265 can include one or more non-transitory computer-readable storage media, such as RAM, ROM, EEPROM, EPROM, one or more memory devices, flash memory devices, etc., and combinations thereof.

The memory 1265 can store information that can be accessed by the one or more processors 1260. For instance, the memory 1265 (e.g., one or more non-transitory computer-readable storage mediums, memory devices) can store data 1275 that can be obtained, received, accessed, written, manipulated, created, and/or stored. The data 1275 can include, for instance, vehicle data, sensor data, configuration data, service assignment data, reconfiguration data, presence data, zone data, and/or other data/information described herein. In some implementations, the computing system 1250 can obtain data from one or more memory device(s) that are remote from the computing system 1250.

The memory 1265 can also store computer-readable instructions 1270 that can be executed by the one or more processors 1260. The instructions 1270 can be software written in any suitable programming language or can be implemented in hardware. Additionally, or alternatively, the instructions 1270 can be executed in logically and/or virtually separate threads on processor(s) 1260. For example, the memory 1265 can store instructions 1270 that when executed by the one or more processors 1260 cause the one or more processors 1260 to perform any of the operations and/or functions described herein, including, for example, any of the operations and functions of the devices described herein, and/or other operations and functions.

The computing device(s) 1255 can also include a communication interface 1280 used to communicate with one or more other system(s). The communication interface 1280 can include any circuits, components, software, etc. for communicating via one or more networks (e.g., 1245). In some implementations, the communication interface 1280 can include for example, one or more of a communications controller, receiver, transceiver, transmitter, port, conductors, software and/or hardware for communicating data/information.

The network(s) 1245 can be any type of network or combination of networks that allows for communication between devices. In some embodiments, the network(s) 1245 can include one or more of a local area network, wide area network, the Internet, secure network, cellular network, mesh network, peer-to-peer communication link and/or some combination thereof and can include any number of wired or wireless links. Communication over the network(s) 1245 can be accomplished, for instance, via a network interface using any type of protocol, protection scheme, encoding, format, packaging, etc.

FIG. 12 illustrates one example system 1200 that can be used to implement the present disclosure. Other computing systems can be used as well. Computing tasks discussed herein as being performed at a cloud services system can instead be performed remote from the cloud services system (e.g., via aerial computing devices, robotic computing devices, facility computing devices, etc.), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method, the method comprising:
obtaining, by a computing system comprising one or more computing devices, vehicle reconfiguration data indicative of a reconfigured interior arrangement for a vehicle interior of an autonomous vehicle,
wherein the reconfigured interior arrangement is different from a current interior arrangement of the vehicle interior;
obtaining, by the computing system, sensor data indicative of one or more objects associated with the autonomous vehicle;
determining, by the computing system, a potential impact of the reconfigured interior arrangement on the one or more objects associated with the autonomous vehicle based at least in part on the vehicle reconfiguration data and the sensor data; and
initiating, by the computing system, a vehicle reconfiguration response based at least in part on the vehicle reconfiguration data and the potential impact of the reconfigured interior arrangement on the one or more objects associated with the autonomous vehicle.

2. The computer-implemented method of claim 1, wherein determining the potential impact of the reconfigured interior arrangement comprises:
obtaining, by the computing system, data indicative of one or more zones of the vehicle interior; and
determining, by the computing system, that at least one of the zones is an impacted zone based at least in part on the vehicle reconfiguration data, wherein the impacted zone is affected by the reconfigured interior arrangement.

3. The computer-implemented method of claim 2, wherein obtaining the data indicative of the one or more zones of the vehicle interior comprises:
determining, by the computing system, the one or more zones of the vehicle interior based, at least in part, on the vehicle reconfiguration data.

4. The computer-implemented method of claim 2, wherein the one or more zones of the vehicle interior are predetermined for the autonomous vehicle.

5. The computer-implemented method of claim 2, wherein the one or more zones comprise one or more clear zones indicative of one or more interior portions of the vehicle interior associated with a low impact level, and
wherein the one or more zones comprise one or more impacted zones comprising the impacted zone, and wherein the one or more impacted zones are indicative of one or more interior portions of the vehicle interior associated with a high impact level.

6. The computer-implemented method of claim 2, wherein determining the potential impact of the reconfigured interior arrangement on the one or more objects associated with the autonomous vehicle comprises:
determining, by the computing system based at least in part on the sensor data, presence data indicative of a position of an object with respect to the impacted zone; and
determining, by the computing system, that the object is located within the impacted zone based at least in part on the presence data.

7. The computer-implemented method of claim 2, wherein determining the potential impact of the reconfigured interior arrangement on the one or more objects associated with the autonomous vehicle comprises:
determining, by the computing system based at least in part on the sensor data, presence data indicative of a predicted position of an object with respect to the impacted zone; and
determining, by the computing system, that the object is to be located within the impacted zone based at least in part on the predicted position of the object.

8. The computer-implemented method of claim 2, wherein the impacted zone is associated with a proximity threshold that identifies an area surrounding the impacted zone.

9. The computer-implemented method of claim 8, wherein initiating the vehicle reconfiguration response comprises:
determining, by the computing system, that at least one object of the one or more objects is or is predicted to be located outside of the proximity threshold associated with the impacted zone; and
initiating, by the computing system, a vehicle reconfiguration of the vehicle interior in response to determining that the at least one object of the one or more objects is or is predicted to be located outside of the proximity threshold.

10. The computer-implemented method of claim 8, wherein initiating the vehicle reconfiguration response comprises:
determining, by the computing system, that at least one object of the one or more objects is or is predicted to be within the proximity threshold associated with the impacted zone; and
initiating, by the computing system, a reconfiguration prompt in response to determining that the at least one object of the one or more objects is within the proximity threshold.

11. The computer-implemented method of claim 1, wherein the vehicle interior comprises a plurality of seats and one or more storage areas, and wherein the reconfiguration data comprises an adjustment to at least one of: (i) a position or orientation of the plurality of seats within the vehicle interior; or (ii) a position or orientation of the one or more storage areas within the vehicle interior.

12. The computer-implemented method of claim 1, wherein the one or more objects comprise one or more users associated with the autonomous vehicle for a requested vehicle service or one or more items associated with the autonomous vehicle for the requested vehicle service.

13. The computer-implemented method of claim 1, wherein the sensor data comprises at least one of interior image data, exterior image data, or tactile data.

14. An autonomous vehicle comprising:
a vehicle interior arranged in accordance with a current interior arrangement; and
a vehicle computing system comprising:
one or more vehicle sensors;
one or more processors; and
one or more non-transitory computer-readable media that collectively store instructions that, when executed by the one or more processors, cause the system to perform operations, the operations comprising:
obtaining vehicle reconfiguration data indicative of a reconfigured interior arrangement for the vehicle interior that is different from the current interior arrangement of the vehicle interior;
obtaining sensor data indicative of one or more objects associated with the autonomous vehicle;
determining first presence data based at least in part on the sensor data, wherein the first presence data indicates at least one of a first current location or first predicted location of the one or more objects;
determining a potential impact of the reconfigured interior arrangement on the one or more objects associated with the autonomous vehicle based at least in part on the vehicle reconfiguration data and the presence data; and
initiating a vehicle reconfiguration response based at least in part on the vehicle reconfiguration data and the potential impact of the reconfigured interior arrangement on the one or more objects associated with the autonomous vehicle.

15. The autonomous vehicle of claim 14, wherein determining the potential impact of the reconfigured interior arrangement on the one or more objects comprises:
determining one or more zones of the vehicle interior based, at least in part, on the vehicle reconfiguration data, wherein the one or more zones comprise at least one impacted zone.

16. The autonomous vehicle of claim 15, wherein determining the one or more zones of the vehicle interior based, at least in part, on the vehicle reconfiguration data comprises:
determining, by the computing system, an impact level for one or more of a plurality of interior portions of the autonomous vehicle based, at least in part, on the reconfigured interior arrangement and the current interior arrangement, wherein the impact level for a respective interior portion is indicative of an estimated impact on the respective interior portion due to the reconfigured interior arrangement.

17. The autonomous vehicle of claim 15, wherein the one or more objects comprise one or more passengers, and wherein the vehicle computing system further comprises:
one or more output devices; and
wherein initiating the vehicle reconfiguration response comprises:
generating a reconfiguration prompt based, at least in part, on the first presence data; and
communicating, via the one or more output devices, the reconfiguration prompt to one or more passengers of the autonomous vehicle.

18. The autonomous vehicle of claim 17, wherein the reconfiguration prompt comprises at least one of a visual cue, an auditory cue, or a tactile cue, and wherein the reconfiguration prompt comprises a request for the one or more passengers to vacate the at least one impacted zone of the vehicle interior.

19. The autonomous vehicle of claim 14, wherein the operations further comprise:
determining second presence data indicative of a second location or a second predicted location of the one or more objects, wherein the second presence data is different than the first presence data;
determining, based at least in part on the second presence data, that the one or more objects are outside of a proximity threshold associated with at least one zone to be impacted by the reconfigured interior arrangement, wherein initiating the vehicle reconfiguration response comprises initiating a vehicle reconfiguration of the vehicle interior from the current interior arrangement to the reconfigured interior arrangement in response to determining that the one or more objects are outside of the proximity threshold.

20. A computing system, the computing system comprising:
one or more processors; and
one or more non-transitory computer-readable media that collectively store instructions that, when executed by the one or more processors, cause the system to perform operations, the operations comprising:
obtaining vehicle reconfiguration data indicative of a reconfigured interior arrangement for the vehicle interior that is different from the current interior arrangement of the vehicle interior;
obtaining presence data associated with one or more objects associated with the autonomous vehicle, wherein the presence data indicates at least one of a current or a predicted location of the one or more objects, wherein the one or more object comprise at least one of a user or an item associated with a vehicle service provided via the autonomous vehicle;
determining a potential impact of the reconfigured interior arrangement on a first object of the one or more objects associated with the autonomous vehicle based at least in part on the vehicle reconfiguration data and the presence data; and
initiating a vehicle reconfiguration response based at least in part on the vehicle reconfiguration data and the potential impact of the reconfigured interior arrangement on the first object, wherein the vehicle reconfiguration response comprises at least one of vehicle reconfiguration or a reconfiguration prompt.
